(19) United States
(12) Patent Application Publication
(10) Pub. No.: US 2025/0283981 A1
(43) Pub. Date: Sep. 11, 2025

(54) MEASURING APPARATUS

(71) Applicant: Panasonic Intellectual Property Management Co., Ltd., Osaka (JP)

(72) Inventors: KENJI NARUMI, Osaka (JP); YASUHISA INADA, Osaka (JP); AKIRA HASHIYA, Osaka (JP)

(21) Appl. No.: 19/215,994

(22) Filed: May 22, 2025

Related U.S. Application Data
(63) Continuation of application No. PCT/JP2023/029062, filed on Aug. 9, 2023.

(30) Foreign Application Priority Data
Dec. 23, 2022 (JP) 2022-206114

(51) Int. Cl. G01S 7/481; G01B 11/26; G01S 17/32

(52) U.S. Cl. CPC G01S 7/4817; G01B 11/26; G01S 17/32

(57) ABSTRACT

A measuring apparatus includes a light source that emits irradiation light for irradiating an object; an adjuster; a scanner; a photodetector; and a processing circuit. The processing circuit performs a first scan operation by causing the scanner to change an irradiation angle, and causing the light source to emit the irradiation light, generates optical detection information through the first scan operation based on reflected light detected by the photodetector, causes the adjuster to set the focus position of a second scan operation based on the optical detection information through the first scan operation, performs the second scan operation by causing the scanner to change the irradiation angle, and causing the light source to emit the irradiation light, generates optical detection information through the second scan operation based on the reflected light detected by the photodetector, and generates distance information of the object based on the optical detection information.

### BACKGROUND

### 1. Technical Field The present disclosure relates to a measuring apparatus.

### 2. Description of the Related Art

In related art, some light detection and ranging (LiDAR) techniques generate measurement data related to the distance and/or the speed of an object by irradiating the object with laser light, and detecting the reflected light from the object. A typical example of a measuring apparatus using the LiDAR technique includes a light source, a photodetector, and a processing circuit. The light source emits irradiation light for irradiating an object. The photodetector detects reflected light from the object, thereby outputting a signal corresponding to a time delay of the reflected light. The processing circuit obtains distance information of the object based on the signal outputted from the photodetector, and outputs a distance measurement result. As an example of a distance measurement method, time of flight (ToF) method and frequency modulated continuous wave (FMCW) method may be mentioned.

When the measuring apparatus further includes a scanner that changes the irradiation angle of irradiation light, the measuring apparatus can sequentially irradiate multiple positions on an object with the irradiation light, the multiple positions being multiple irradiation points. As a result, the distance information of the multiple irradiation points on the object can be mapped one-dimensionally or two-dimensionally so that the shape of the object can be measured. Japanese Unexamined Patent Application Publication No. 2013-117453 discloses an example of a measuring apparatus that measures the shape of an object by such a method.

### SUMMARY

One non-limiting and exemplary embodiment provides a measuring apparatus that can accurately generate distance information of an irradiation point on an object using a simple configuration.

In one general aspect, the techniques disclosed here feature a measuring apparatus comprising: a light source that emits irradiation light for irradiating an object; an adjuster that adjusts a focus position of the irradiation light; a scanner that changes an irradiation angle of the irradiation light; a photodetector that detects reflected light from the object and outputs a signal; and a processing circuit that controls the light source, the adjuster, and the scanner, and that processes the signal outputted from the photodetector. The processing circuit performs a first scan operation by causing the scanner to change the irradiation angle, and causing the light source to emit the irradiation light, generates optical detection information through the first scan operation based on the reflected light detected by the photodetector, causes the adjuster to set the focus position of a second scan operation based on the optical detection information through the first scan operation, performs the second scan operation by causing the scanner to change the irradiation angle, and causing the light source to emit the irradiation light, generates optical detection information through the second scan operation based on the reflected light detected by the photodetector, and generates distance information of the object based on the optical detection information through the second scan operation.

It should be noted that general or specific embodiments of the present disclosure may be implemented as a system, an apparatus, a method, an integrated circuit, a computer program, a storage medium such as a computer-readable recording disc, or any selective combination thereof. The computer-readable recording disc may include, for example, a non-volatile recording medium such as a compact disc-read only memory (CD-ROM). The apparatus may be comprised of one or more apparatuses. When the apparatus is comprised of two or more apparatuses, the two or more apparatuses may be disposed within one machine, or within two or more separate machines in a distributed manner. In the scope of the present specification and the appended claims, an “apparatus” can refer to not only one apparatus, but also a system comprised of a plurality of apparatuses. The plurality of apparatuses included in the “system” may also include an apparatus installed at a remote place away from other apparatuses and connected through a communication network.

According to the technique of the present disclosure, it is possible to implement a measuring apparatus that can accurately generate distance information of an irradiation point on an object using a simple configuration.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a block diagram schematically illustrating the configuration of a measuring apparatus according to an exemplary embodiment of the present disclosure;

FIG. 1B is a view schematically illustrating a configuration example of a focus adjuster and a scanner;

FIG. 1C is a diagram schematically illustrating a configuration example of a processing device;

FIG. 2A is a chart schematically illustrating an example of a table for adjusting a focus position;

FIG. 2B is a chart schematically illustrating another example of a table for adjusting a focus position;

FIG. 3A is a block diagram schematically illustrating the configuration of a measuring apparatus according to another exemplary embodiment of the present disclosure;

FIG. 3B is a block diagram schematically illustrating the configuration of a measuring apparatus according to still another exemplary embodiment of the present disclosure;

FIG. 4 is a graph schematically illustrating time variation of the frequency of reference light and reflected light when an object is still;

FIG. 5 is a flowchart schematically illustrating Example 1 of measurement operation performed by a processing circuit in the measuring apparatus according to the exemplary embodiment;

FIG. 6A is a flowchart schematically illustrating an example of a focus position adjustment operation performed by the processing circuit in the measuring apparatus according to the exemplary embodiment;

FIG. 6B is a graph illustrating a relationship between the focus position and the intensity of an optical detection signal;

FIG. 7A is a flowchart schematically illustrating Example 2 of measurement operation performed by the processing circuit in the measuring apparatus according to the exemplary embodiment;

FIG. 7B is a graph when irradiation points p₁ to p₆ are sequentially irradiated, the graph schematically illustrating an example of a relationship between the irradiation points p₁ to p₆ and the absolute value of the difference between the distance to each irradiation point and the distance to the immediately preceding irradiation point.

FIG. 8A is a flowchart schematically illustrating Example 3 of measurement operation performed by the processing circuit in the measuring apparatus according to the exemplary embodiment;

FIG. 8B is a graph when irradiation points p₁ to p₆ are sequentially irradiated, the graph schematically illustrating an example of a relationship between the irradiation points p₁ to p₆ and the intensity of an optical detection signal;

FIG. 9A is a flowchart schematically illustrating a first scan operation in Example 4 of measurement operation performed by the processing circuit in the measuring apparatus according to the exemplary embodiment;

FIG. 9B is a chart schematically illustrating an example of a table showing a relationship between the irradiation angle and the distance generated in the first scan operation;

FIG. 9C is a flowchart schematically illustrating a second scan operation in Example 4 of measurement operation performed by the processing circuit in the measuring apparatus according to the exemplary embodiment;

FIG. 9D is a graph schematically illustrating an example of a relationship between the irradiation point and the distance in the first and second scan operations;

FIG. 10A is a graph illustrating a relationship between the distance to irradiation point and the intensity of an optical detection signal; and

FIG. 10B is a graph illustrating a relationship between irradiation angle and reduction in signal intensity.

### DETAILED DESCRIPTIONS

In the present disclosure, all or part of a circuit, a unit, an apparatus, a member or a component, or all or part of a functional block in a block diagram may be executed by one or more electronic circuits including, for example, a semiconductor device, a semiconductor integrated circuit (IC) or large-scale integration (LSI). LSIs or ICs may be integrated in one chip, or may be comprised of chips combined. For example, the functional blocks other than a storage element may be integrated in one chip. Herein, a relevant component is referred to as LSI or IC, however, may be referred to as system LSI, very large-scale integration (VLSI), or ultra large-scale integration (ULSI) depending on the degree of integration. A field programmable gate array (FPGA) programed after LSI is manufactured, and a reconfigurable logic device which allows reconfiguration of a connection relationship inside LSI or setup of a circuit division inside LSI also can be used for the same purpose.

In addition, the function or operation of all or part of a circuit, a unit, an apparatus, a member or a component can be performed by software processing. In this case, when software is recorded on a non-transitory recording medium such as one or more ROMs, an optical disc, a hard disk drive, and is executed by a processing device (processor), the function specific to the software is performed by a processing device and a peripheral device. The system or the apparatus may include one or more non-transitory recording media on which software is recorded, a processing device, and a required hardware device, for example, an interface.

In the present disclosure, “light” means not only visible light (with a wavelength of approximately 400 nm to approximately 700 nm), but also an electromagnetic ray including ultraviolet ray (with a wavelength of approximately 10 nm to approximately 400 nm) and infrared ray (with a wavelength of approximately 700 nm to approximately 1 mm). In the present specification, ultraviolet ray may be referred to as “ultraviolet light”, and infrared ray may be referred to as “infrared light”.

Hereinafter, an exemplary embodiment of the present disclosure will be described. The embodiments described below each show a general or specific example. The numerical values, shapes, materials, components, arrangement, positions and connection topologies of the components, steps, the order of the steps which are shown in the following embodiments are examples, and not intended to limit the technique of the present disclosure. Of the components of the embodiments below, those not described in the independent claim that defines the most generic concept are each described as an arbitrary component. It should be noted that the drawings are schematically illustrated, and are not necessarily illustrated accurately. In addition, substantially the same or similar components are labeled with the same symbol in the drawings. A redundant description may be omitted or simplified.

First, the knowledge on which the present disclosure is based will be described.

When an irradiation point on an object is irradiated with irradiation light, if the intensity of reflected light from the irradiation point is low, the accuracy of distance information of the irradiation point is reduced. In order to increase the intensity of reflected light, the measuring apparatus disclosed in Japanese Unexamined Patent Application Publication No. 2013-117453 adopts a configuration called a low precision distance measurement system and a configuration called a high precision distance measurement system. The distance to an irradiation point on an object is measured using the low precision distance measurement system, and based on the result of the measurement, the focus position of the irradiation light is adjusted, and the distance to the irradiation point on the object is measured in the high precision distance measurement system. The spot size of the irradiation light at the irradiation point can be minimized by adjusting the focus position of the irradiation light. As a result, the intensity of reflected light from the irradiation point is increased, thus distance information of the irradiation point can be accurately generated. In contrast, the measuring apparatus disclosed in Japanese Unexamined Patent Application Publication No. 2013-117453 needs different configurations for the low precision distance measurement system and the high precision distance measurement system, resulting in a complicated configuration of the measuring apparatus.

The inventors have conceived the measuring apparatus according to the exemplary embodiment of the present disclosure to solve the above-mentioned problem. In the measuring apparatus according to the exemplary embodiment, an operation for focus position determination and an operation for distance measurement are performed, and a common configuration is used in these operations. Therefore, distance information of an irradiation point on an object can be accurately generated using a simple configuration.

### Exemplary Embodiments

### Measuring Apparatus Utilizing LiDAR Technique in ToF Method

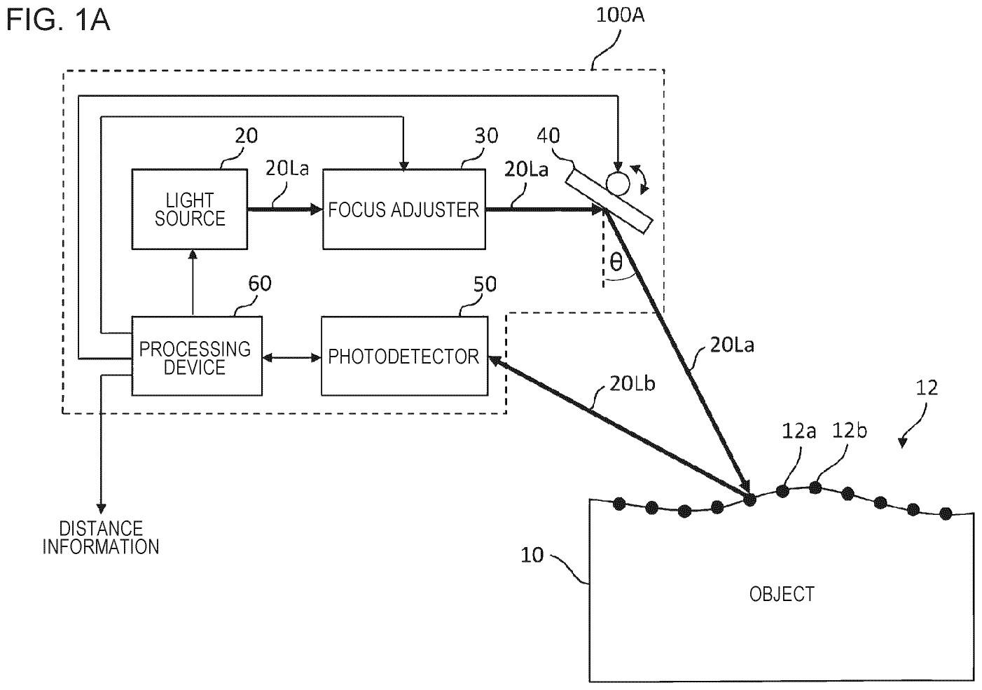

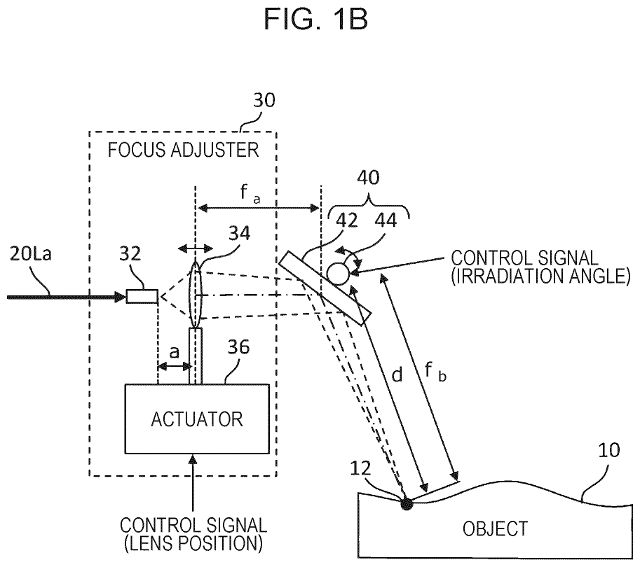

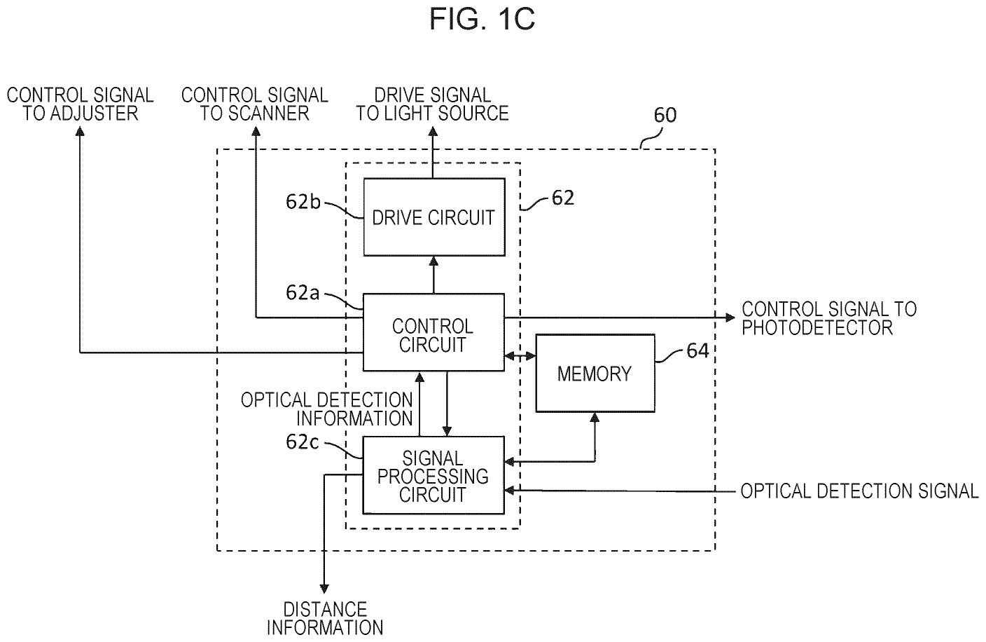

First, referring to FIGS. 1A to 1C, a configuration example of a measuring apparatus utilizing LiDAR technique in ToF method according to the exemplary embodiment of the present disclosure will be described. FIG. 1A is a block diagram schematically illustrating the configuration of a measuring apparatus according to the exemplary embodiment of the present disclosure. FIG. 1A also illustrates an object 10 as a measurement target. A measuring apparatus 100A illustrated in FIG. 1A measures the shape of the object 10 utilizing the LiDAR technique in the ToF method. As illustrated in FIG. 1A, the measuring apparatus 100A includes a light source 20, a focus adjuster 30, a scanner 40, a photodetector 50, and a processing device 60. In the present specification, the focus adjuster 30 is also referred to as simply the “adjuster 30”. The thick line with an arrow illustrated in FIG. 1A indicates the path of light, and the thin line with an arrow indicates the path of a signal. The same also applies to other figures.

FIG. 1B is a view schematically illustrating a configuration example of the focus adjuster 30 and the scanner 40. As illustrated in FIG. 1B, the focus adjuster 30 includes an optical element 32, a lens 34, and an actuator 36. The optical element 32 may be e.g., an optical fiber. The scanner 40 includes a mirror 42, and a driver 44 that alters the direction of the mirror 42. FIG. 1C is a diagram schematically illustrating a configuration example of the processing device 60. As illustrated in FIG. 1C, the processing device 60 includes a processing circuit 62, and a memory 64 such as a ROM or a RAM.

In the measuring apparatus 100A according to the exemplary embodiment, each of irradiation points 12 on the object 10 is irradiated with irradiation light 20La emitted from the light source 20 and having a focus position appropriately set by the focus adjuster 30, and the distance from the measuring apparatus 100A to the irradiation point 12 is measured based on reflected light 20Lb from the irradiation point 12. In the present specification, the distance from the measuring apparatus 100A to the irradiation point 12 is simply referred to as the “distance to the irradiation point 12”.

Although the details will be described later, in the measuring apparatus 100A according to the exemplary embodiment, an operation for focus position determination and an operation for distance measurement are performed, and a common configuration is used in these operations. Therefore, distance information of the irradiation point 12 on the object 10 can be accurately generated using a simple configuration. The same applies to the later-described measuring apparatus 100B and measuring apparatus 100C.

The object 10 and the components of the measuring apparatus 100A will be describe below.

### Object 10

The object 10 may be e.g., a structure on a construction site, or a large product manufactured in a factory. The structure may be comprised of e.g., a concrete member, a metal member, or a wood material. The factory product may be e.g., an automobile, a home electric appliance, or a mechanical component. Note that in the present specification, an example of the object 10 in a large size is used as a measurement target; however, a non-large object may be used as a measurement target depending on the application.

### Light Source 20

The light source 20 emits irradiation light 20La for irradiating the object 10. The irradiation light 20La may be e.g., a laser beam having high coherence. The wavelength of the laser beam can be included in the wavelength range of far-red light, that is, greater than or equal to 700 nm and less than or equal to 2000 nm. The sunlight includes far-red light and visible light, and the amount of far-red light is less than the amount of visible light. Therefore, when far-red light is used as a laser beam, the effect of the sunlight as noise can be reduced. The wavelength of the laser beam is not necessarily included in the wavelength range of far-red light. The wavelength of the laser beam may be included in the wavelength range of visible light, that is, greater than or equal to 400 nm and less than or equal to 700 nm, or included in the wavelength range of ultraviolet light.

The light source may include e.g., a distributed-feedback (DFB) laser diode, an external cavity (EC) laser diode, or a vertical cavity surface emitting laser (VCSEL) laser diode. These laser diodes are inexpensive and compact, and single-mode oscillation is possible.

### Focus Adjuster 30

As illustrated in FIG. 1B, the focus adjuster 30 receives a control signal sent from the processing circuit 62, and adjusts the focus position of the irradiation light 20La. The control signal includes information on the position of the lens 34. The “control signal (lens position)” shown in FIG. 1B means a control signal including information on the position of the lens 34.

The optical element 32 may be e.g., an optical fiber. The optical element 32 emits the irradiation light 20La with diffused in the air. The lens 34 converges the diffused irradiation light 20La. The scanner 40 reflects the irradiation light 20La to the object 10 by the mirror 42. As a result, the irradiation point 12 on the object 10 is irradiated with the irradiation light 20La.

The point with a minimum spot size of the irradiation light 20La is defined as the focus point, and the length from the principal point to the focus point of the lens 34 is defined as the focus position. Let fa be the distance from the principal point of the lens 34 to the reflection point of the mirror 42, let f_{b} be the distance from the reflection point of the mirror 42 to the focus position, then the focus position fₚ is represented by fₚ=fₐ+f_{b}. The reflection point of the mirror 42 is the center of the area in the mirror 42, on which the irradiation light 20La is incident. The distance from the reflection point of the mirror 42 to the irradiation point 12 is defined as the measured distance d. When the focus point matches the irradiation point 12, f_{b}=d and the reflected light 20Lb has the highest intensity. Therefore, the focus position satisfying f_{b}=d is an optimal focus position at which the most accurate distance information of the irradiation point 12 can be generated.

The actuator 36 receives the above-mentioned control signal, and moves the lens 34 in the optical axis direction. The distance between a certain reference position and the principal point of the lens 34 in the optical axis direction is defined as the lens position. Let a be the lens position. The reference position may be e.g., the end of the optical element 32, closer to the lens 34. The actuator 36 can change the focus position fp by adjusting the lens position a.

### Scanner 40

As illustrated in FIG. 1B, the scanner 40 receives a control signal sent from the processing circuit 62, and changes the irradiation angle of the irradiation light 20La. The control signal includes information on the irradiation angle. The “control signal (irradiation angle)” shown in FIG. 1B means a control signal including information on the irradiation angle.

The mirror 42 may be e.g., a micro electro mechanical system (MEMS) mirror, a galvano mirror, or a polygon mirror. The driver 44 receives the above-mentioned control signal, and alters the direction of the mirror 42. As a result, an irradiation angle θ of the irradiation light 20La reflected by the mirror 42 is changed, and the position of the irradiation point 12 on the object 10 is changed.

Note that instead of altering the direction of the mirror 42, the position of the irradiation point 12 on the object 10 may be changed by altering the direction of the focus adjuster 30 itself, or the optical element 32 and the lens 34 included in the focus adjuster 30.

### Photodetector 50

The photodetector 50 receives a control signal sent from the processing circuit 62 to detect the reflected light 20Lb from the object 10, and outputs an optical detection signal according to the intensity of the reflected light 20Lb. The control signal includes information on detection timing and/or output timing of the optical detection signal. Note that the processing circuit 62 may sample an optical detection signal at a predetermined timing in a state where the photodetector 50 always detects the reflected light 20Lb. In that case, the processing circuit 62 does not need to send the above-mentioned control signal, and the photodetector 50 does not need to receive the control signal.

The photodetector 50 includes one or more photodiodes. A photodiode outputs a signal according to the intensity of the reflected light 20Lb. The photodetector 50 may include a preamplifier that amplifies a signal.

### Processing Device 60

As illustrated in FIG. 1C, the processing circuit 62 includes a control circuit 62a, a drive circuit 62b, and a signal processing circuit 62c. The control circuit 62a sends a control signal including information on the lens position to the focus adjuster 30 to control the focus adjuster 30. The control circuit 62a send information including the irradiation angle to the scanner 40 to control the scanner 40. The control circuit 62a sends a control signal including information on detection timing and/or output timing to the photodetector 50 to control the photodetector 50.

The control circuit 62a sends a control signal including information on the intensity and emission timing of the irradiation light 20La to the drive circuit 62b to control the drive circuit 62b. The drive circuit 62b sends a drive signal to the light source 20 to drive the light source 20. The drive signal may be e.g., a voltage signal or a current signal. It can be also said that the control circuit 62a controls the light source 20 through the drive circuit 62b. The control circuit 62a sends a control signal including information of signal processing to the signal processing circuit 62c to control the signal processing circuit 62c.

The signal processing circuit 62c processes the optical detection signal outputted from the photodetector 50, thereby generating and outputting optical detection information for appropriately setting the focus position for the irradiation point 12. The signal processing circuit 62c sends the optical detection information to the control circuit 62a. The control circuit 62a sends a control signal including information on the lens position to the focus adjuster 30 based on the optical detection information. The optical detection information may be e.g., information on the focus position for the irradiation point measured before the subsequently measured irradiation point. Alternatively, the optical detection information may be e.g., information on the intensity of the reflected light 20Lb from the irradiation point measured before the subsequently measured irradiation point, or distance information of the irradiation point measured before the subsequently measured irradiation point.

The signal processing circuit 62c further generates and outputs distance information of the irradiation point 12 by the LiDAR technique in the ToF method. As the ToF method, a direct ToF method may be used, or an indirect ToF method may be used. The shape of the object 10 can be measured by mapping the distance information of all the multiple irradiation points 12 illustrated in FIG. 1A one-dimensionally or two-dimensionally.

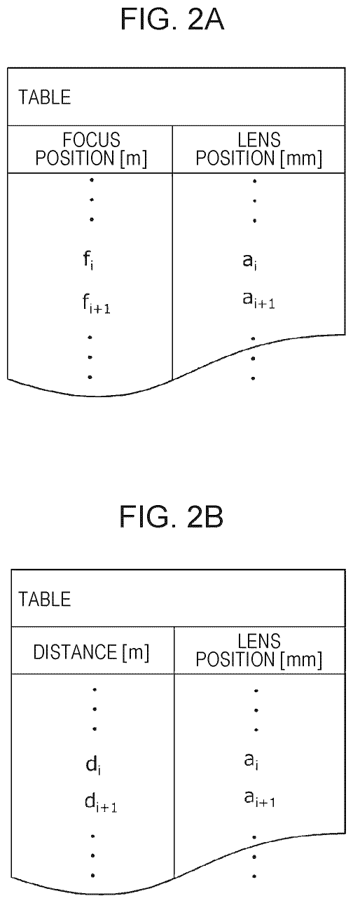

The memory 64 stores a table for adjusting the focus position. FIGS. 2A and 2B are charts schematically illustrating an example of a table for adjusting the focus position. The table illustrated in FIG. 2A is a table that establishes a relationship between focus position fᵢ and lens position aᵢ. The table illustrated in FIG. 2B is a table that establishes a relationship between distance dᵢ and lens position aᵢ. The subscript “i” indicates that the value in the list is the ith from the top.

When the optical detection information is information on the focus position, the control circuit 62a obtains information on a lens position aᵢ corresponding to the focus position fᵢ from the table illustrated in FIG. 2A, and sends a control signal including the information on the lens position aᵢ to the focus adjuster 30.

When the optical detection information is distance information of the irradiation point 12, the control circuit 62a calculates the focus position fₚ from the distance d based on the above-mentioned relationship fₚ=d+fₐ, and subsequently, obtains information on the lens position aᵢ from the table illustrated in FIG. 2A, and sends the control signal to the focus adjuster 30. Alternatively, the control circuit 62a may obtain information on a lens position aᵢ corresponding to the distance dᵢ from the table illustrated in FIG. 2B, and may send a control signal including information on the lens position aᵢ to the focus adjuster 30. The control circuit 62a may calculate the lens position aᵢ by a conversion formula without using the table as shown above.

The signal processing circuit 62c may input distance information of the irradiation point 12 to a display which is not illustrated. The display displays the distance information of the irradiation point 12. Alternatively, the signal processing circuit 62c may input the outputted distance information of the irradiation point 12 to another apparatus. Another apparatus performs a specific operation based on the distance information of the irradiation point 12. Another apparatus may be e.g., a vehicle or an industrial robot.

A computer program executed by the control circuit 62a and the signal processing circuit 62c is stored in the memory 64. The processing circuit 62 and the memory 64 may be integrated in one circuit board, or provided in separate circuit boards. The control circuit 62a, the drive circuit 62b, and the signal processing circuit 62c included in the processing circuit 62 may be distributed in a plurality of circuits. The processing device 60 or part thereof may be installed at a remote place away from other components to control the light source 20, the focus adjuster 30, the scanner 40, and the photodetector 50 through a wireless or wired communication network.

### Measuring Apparatus Utilizing LiDAR Technique in FMCW Method

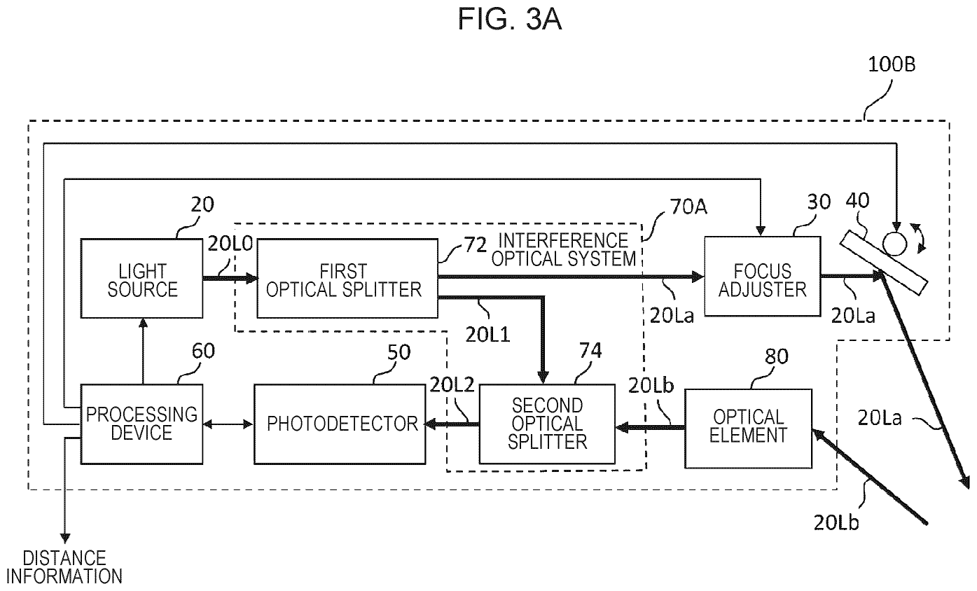

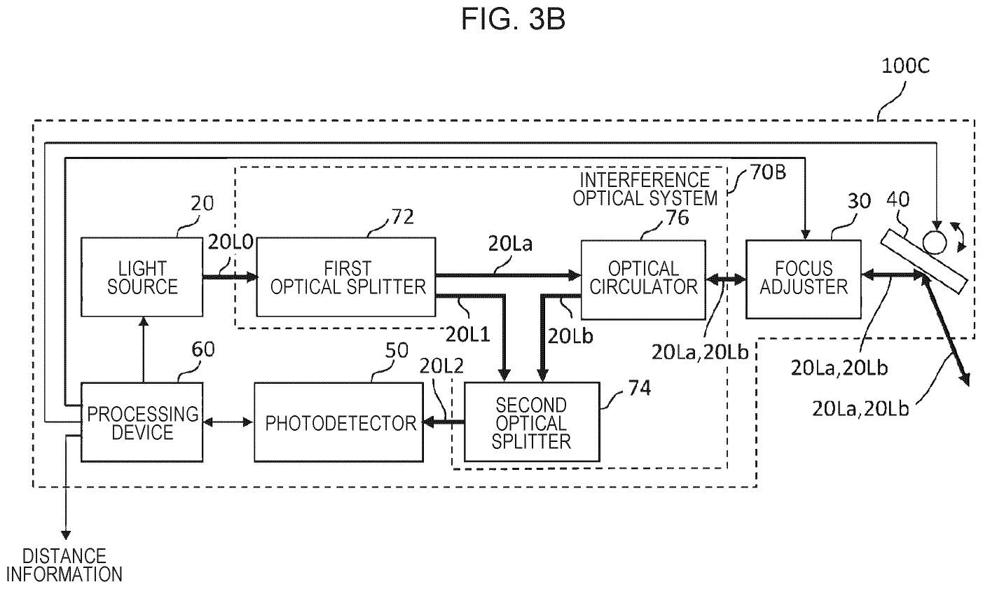

Next, a configuration example of a measuring apparatus according to the exemplary embodiment of the present disclosure utilizing the LiDAR technique in the FMCW method, in other words, FMCW-LiDAR technique will be described with reference to FIGS. 3A and 3B. FIG. 3A is a block diagram schematically illustrating the configuration of a measuring apparatus according to another exemplary embodiment of the present disclosure. A measuring apparatus 100B illustrated in FIG. 3A measures the shape of the object 10 utilizing the FMCW-LiDAR technique. The measuring apparatus 100B illustrated in FIG. 3A differs from the measuring apparatus 100A illustrated in FIG. 1A in the following three points. The first point is that the light source 20 emits light 20L0 which is frequency-modulated. The second point is that the measuring apparatus 100B includes an interference optical system 70A between the light source 20 and the focus adjuster 30. The third point is that the measuring apparatus 100B includes an optical element 80.

Hereinafter, the components of the measuring apparatus 100B will be described focused on the points of difference from the measuring apparatus 100A illustrated in FIG. 1A.

### Light Source 20

The light source 20 emits frequency-modulated light 20L0. The light 20L0 may be e.g., a laser beam. The frequency of the light 20L0 may vary with time, for example, in a triangular wave shape or a sawtooth shape with a constant time period. The time period may be, for example, greater than or equal to 1 u sec and less than or equal to 10 m sec. The time period may vary. The variation width of the frequency may be, for example, greater than or equal to 100 MHz and less than or equal to 1 THz. The wavelength of the light 20L0 is the same as the wavelength of the above-mentioned irradiation light 20La.

The laser diode included in the light source 20 is as mentioned above. The above-mentioned laser diode can modulate the frequency of the light 20L0 according to the amount of current applied.

### Interference Optical System 70A

The interference optical system 70A includes a first optical splitter 72, and a second optical splitter 74. The first optical splitter 72 and the focus adjuster 30 are coupled to each other by an optical fiber. The same applies to the coupling between the first optical splitter 72 and the second optical splitter 74, the coupling between the second optical splitter 74 and the photodetector 50, and the coupling between the second optical splitter 74 and the optical element 80.

The first optical splitter 72 splits the light 20L0 emitted from the light source 20, and outputs reference light 20L1 and the irradiation light 20La for irradiating the object 10. The intensity of the reference light 20L1 may be, for example, greater than or equal to 1% and less than or equal to 10% of the intensity of the light 20L0 which is input to the first optical splitter 72. The first optical splitter 72 inputs the outputted reference light 20L1 to the second optical splitter 74, and inputs the outputted irradiation light 20La to the focus adjuster 30.

The second optical splitter 74 inputs interference light 20L2 to the photodetector 50, the interference light 20L2 being obtained by superimposing the reference light 20L1 and the reflected light 20Lb for interference. The photodetector 50 detects the interference light 20L2 and outputs an optical detection signal according to the intensity of the interference light 20L2.

### Optical Element 80

The optical element 80 causes the reflected light 20Lb to be incident on the optical fiber coupling the optical element 80 to the second optical splitter 74. The optical element 80 may include at least one selected from a group consisting of e.g., a condensing lens, a collimator lens, a diffusing lens, and a diffraction grating.

The measuring apparatus according to the exemplary embodiment of the present disclosure utilizing the FMCW-LiDAR technique is not limited to the measuring apparatus 100B illustrated in FIG. 3A. FIG. 3B is a block diagram schematically illustrating the configuration of a measuring apparatus according to still another exemplary embodiment of the present disclosure. As the measuring apparatus 100B illustrated in FIG. 3A, the measuring apparatus 100C illustrated in FIG. 3B measures the shape of the object 10 utilizing the FMCW-LiDAR technique. The measuring apparatus 100C illustrated in FIG. 3B differs from the measuring apparatus 100B illustrated in FIG. 3A in the following two points. The first point is that the measuring apparatus 100C includes an interference optical system 70B instead of the interference optical system 70A illustrated in FIG. 3A. The second point is that the measuring apparatus 100C does not include the optical element 80 illustrated in FIG. 3A.

Hereinafter, the components of the measuring apparatus 100C will be described focused on the points of difference from the measuring apparatus 100B illustrated in FIG. 3A.

### Interference Optical System 70B

The interference optical system 70B includes an optical circulator 76 in addition to the first optical splitter 72 and the second optical splitter 74 illustrated in FIG. 3A. The first optical splitter 72 and the optical circulator 76 are coupled to each other by an optical fiber. The same applies to the coupling between the first optical splitter 72 and the second optical splitter 74, the coupling between the optical circulator 76 and the focus adjuster 30, the coupling between the optical circulator 76 and the second optical splitter 74, and the coupling between the second optical splitter 74 and the photodetector 50.

The first optical splitter 72 inputs the outputted reference light 20L1 to the second optical splitter 74, and inputs the outputted irradiation light 20La to the optical circulator 76.

The optical circulator 76 outputs the irradiation light 20La from the first optical splitter 72, and inputs the irradiation light 20La to the focus adjuster 30. The optical circulator 76 further outputs reflected light 20Lb, and inputs the reflected light 20Lb to the second optical splitter 74, the reflected light 20Lb to be input to the optical circulator 76 through the scanner 40 and the focus adjuster 30 in that order.

Unlike the measuring apparatus 100B illustrated in FIG. 3A, in the measuring apparatus 100C, the optical path of the irradiation light 20La from the interference optical system 70B to the object 10, and the optical path of the reflected light 20Lb from the object 10 to the interference optical system 70B overlap on the same axis.

In the measuring apparatus 100C, not only the focus position is adjusted to be located on the object 10, but also the focus point of the reflected light 20Lb is adjusted to be located at the end of the optical elements 32 illustrated in FIG. 1B. Therefore, as compared to the measuring apparatus 100B illustrated in FIG. 3A, the intensity of the interference light 20L2 can be further increased, and the measurable distance range can be further expanded. The optical element 32 emits the irradiation light 20La in the air. The irradiation light 20La is incident on the object 10 through the lens 34 and the scanner 40 in that order. The optical element 32 further receives the reflected light 20Lb, and inputs the reflected light 20Lb to the photodetector 50 through the optical circulator 76 and the second optical splitter 74 in that order. Since the measuring apparatus 100C adopts a coaxial optical system in which the optical paths of the irradiation light 20La and the reflected light 20Lb overlap on the same axis, the configuration of the measuring apparatus 100C can be simplified, and stable measurement can be achieved.

In the measuring apparatus 100B illustrated in FIG. 3A and the measuring apparatus 100C illustrated in FIG. 3B, the signal processing circuit 62c included in the processing device 60 generates and outputs optical detection information for appropriately setting the focus position for the irradiation point 12. The signal processing circuit 62c further generates and outputs distance information of the irradiation point 12 by the FMCW-LiDAR technique. The signal processing circuit 62c may generate and output speed information of the irradiation point 12 by the FMCW-LiDAR technique.

### FMCW-LiDAR Technique

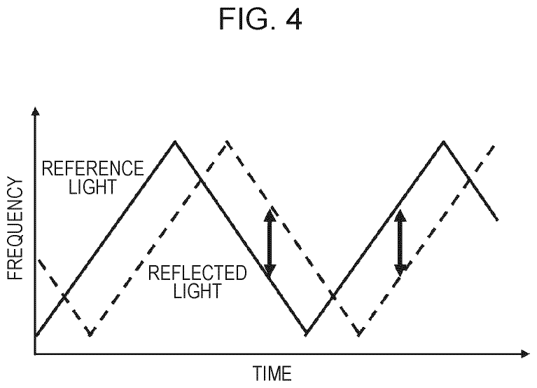

Next, the FMCW-LiDAR technique will be briefly described with reference to FIG. 4. The details of the FMCW-LiDAR technique are disclosed, for example, in Christopher V. Poultonet al., “Frequency-modulated Continuous-wave LIDAR Module in Silicon Photonics”, 2016 Optical Fiber Communications Conference and Exhibition (OFC), Mar. 20, 2016.

FIG. 4 is a graph schematically illustrating time variation in the frequency of the reference light 20L1 and the reflected light 20Lb when an object is still. The solid line illustrated in FIG. 4 indicates the reference light 20L1, and the dashed line illustrated in FIG. 4 indicates the reflected light 20Lb. The frequency of the reference light 20L1 illustrated in FIG. 4 repeats time variation in a triangular wave form. In other words, the frequency of the reference light 20L1 repeats up-chirp and down-chirp. The increase in the frequency during the up-chirp period is equal to the decrease in the frequency during the down-chirp period. As compared to the frequency of the reference light 20L1, the frequency of the reflected light 20Lb is shifted in the positive direction along the time axis. The amount of time shift of the reflected light 20Lb is equal to the time since emission of the irradiation light 20La from the measuring apparatus 100B or the measuring apparatus 100C to the outside until the irradiation light 20La is reflected by the object 10 and returned as the reflected light 20Lb. As a result, the interference light 20L2 obtained by superimposing the reference light 20L1 and the reflected light 20Lb for interference has a frequency corresponding to the difference between the frequency of the reflected light 20Lb and the frequency of the reference light 20L1. Two-way arrows illustrated in FIG. 4 indicate the frequency difference in both light. The photodetector 50 outputs a signal showing the intensity of the interference light 20L2. The signal is referred to as a beat signal. The frequency of the beat signal, that is, the beat frequency is equal to the frequency difference mentioned above. The signal processing circuit 62c can generate distance information of the object 10 from the beat frequency.

When the object 10 is still, the beat frequency in the up-chirp period and the beat frequency in the down-chirp period are equal to each other. Let Δf be the increase or decrease in the frequency of light during the up-chirp period or the down-chirp period, Δt be the time required for change of Δf, c be the speed of light, and 2d be the difference between the optical path length of the reference light 20L1 and the total of the optical path lengths of the irradiation light 20La and the reflected light 20Lb, then the beat frequency f_{beat} in the up-chirp period or the down-chirp period is expressed by the following

$${f}_{beat} = \frac{2 Δ f}{c Δ t} d \qquad ( 1 )$$

The beat frequency f_{beat} in Expression (1) is obtained by multiplying the time variation rate Δf/Δt of the frequency by the time (2d/c) since emission of the irradiation light 20La from the distance measuring apparatus to the outside until the irradiation light 20La is reflected by the object and returned as the reflected light.

When the object 10 moves, the frequency of the reflected light 20Lb is Doppler-shifted relative to the frequency of the reference light 20L1 in the positive direction or the negative direction along the frequency axis. In this case, the beat frequency in the up-chirp period and the beat frequency in the down-chirp period are different from each other. The signal processing circuit 62c can generate each of speed information and distance information of the object 10 from the difference and the average between these beat frequencies.

### Example 1 of Measurement Operation

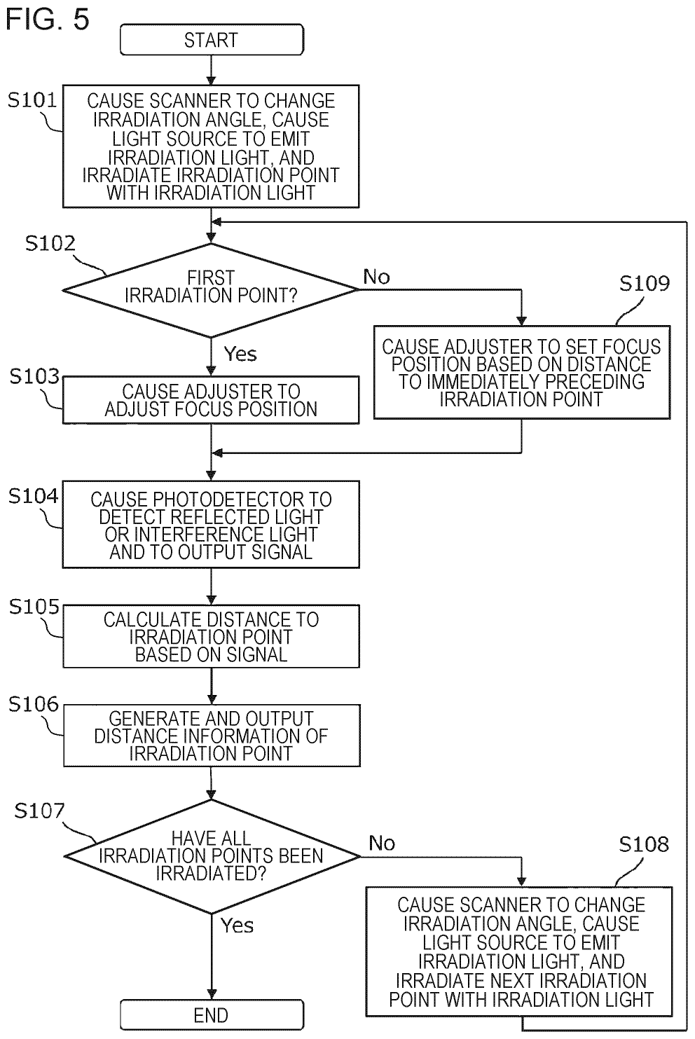

Next, Example 1 of measurement operation performed by the measuring apparatuses 100A to 100C for measuring the shape of the object 10 according to the exemplary embodiment will be described with reference to FIG. 5. FIG. 5 is a flowchart schematically illustrating Example 1 of measurement operation performed by the processing circuit 62 in the measuring apparatuses 100A to 100C according to the exemplary embodiment. The processing circuit 62 executes the operation in steps S101 to S109 illustrated in FIG. 5.

### Step S101

The processing circuit 62 causes the scanner 40 to change the irradiation angle of the irradiation light 20La, causes the light source 20 to emit the irradiation light 20La, and irradiates the irradiation point 12 to be measured with the irradiation light 20La. In the measuring apparatus 100B illustrated in FIG. 3A and the measuring apparatus 100C illustrated in FIG. 3B, the light source 20 emits the light 20L0; however, since the light 20L0 includes the irradiation light 20La, it can be said that the light source 20 emits the irradiation light 20La.

### Step S102

The processing circuit 62 determines whether an irradiation point to be measured is the first point. When the determination is Yes, the processing circuit 62 performs the operation in step S103. When the determination is No, the processing circuit 62 performs the operation in step S109.

### Step S103

When the irradiation point 12 is the first point, the processing circuit 62 has not obtained information on the optimal focus position for the irradiation point 12. Therefore, the processing circuit 62 causes the focus adjuster 30 to adjust the focus position to set the focus position to an optimal focus position. The details of the adjustment operation will be described below.

### Step S104

The processing circuit 62 causes the photodetector 50 to detect the reflected light 20Lb and to output an optical detection signal. In the measuring apparatus 100B or the measuring apparatus 100C, the processing circuit 62 causes the photodetector 50 to detect the interference light 20L2 and to output an optical detection signal; however, since the interference light 20L2 includes the reflected light 20Lb, it can be said that the photodetector 50 detects the reflected light 20Lb.

Note that the processing circuit 62 may sample an optical detection signal at a predetermined timing in a state where the photodetector 50 always detects the reflected light 20Lb or the interference light 20L2.

### Step S105

The processing circuit 62 calculates the distance to the irradiation point 12 based on the optical detection signal. When the FMCW-LiDAR technique is utilized, the processing circuit 62 Fourier-transforms the time waveform of the optical detection signal to obtain the frequency of the beat signal, and converts the frequency to a distance.

### Step S106

The processing circuit 62 generates and outputs distance information indicating the distance to the irradiation point 12. The distance may be displayed as a numerical value on a display, or the numerical values of multiple distances may be displayed as a graph on a display. Alternatively, the processing circuit 62 may send distance information of the irradiation point 12 to another apparatus.

The processing circuit 62 stores the distance information of the irradiation point 12 in the memory 64. The processing circuit 62 may store, in the memory 64, information on the focus position for the irradiation point 12 instead of the distance information of the irradiation point 12.

### Step S107

The processing circuit 62 determines whether all irradiation points 12 have been irradiated. When the determination is Yes, the processing circuit 62 completes the measurement operation. When the determination is No, the processing circuit 62 performs the operation in step S108.

### Step S108

When an irradiation point 12 to be measured remains, the processing circuit 62 causes the scanner 40 to change the irradiation angle of the irradiation light 20La, causes the light source 20 emit the irradiation light 20La, and irradiates the next irradiation point 12 which has not been measured yet with the irradiation light 20La. The next irradiation point 12 is located in the vicinity of the irradiation point 12 measured immediately before. The absolute value of the difference in the irradiation angles for these two irradiation points 12 may be less than or equal to e.g., 10 degrees. Alternatively, the absolute value of the difference in the irradiation angles may be less than or equal to e.g., 7.5 degrees, or less than or equal to 5 degrees. For a smaller absolute value of the difference in the irradiation angles, the shape of the object 10 can be studied in more detail.

### Step S109

In step S102, when the irradiation point 12 to be measured subsequently is determined not to be the first point, the processing circuit 62 causes the focus adjuster 30 to set the focus position based on the distance to the immediately preceding irradiation point 12. More specifically, the processing circuit 62 determines the focus position based on the distance to the immediately preceding irradiation point 12, and causes the focus adjuster 30 to set the current focus position to the determined focus position. In this operation, the processing circuit 62 obtains the distance to the immediately preceding irradiation point 12 from the memory 64, and obtains a lens position corresponding to the distance from the table illustrated in FIG. 2B. When the lens position is determined, the focus position is determined. The processing circuit 62 sends a control signal including information on the lens position to the focus adjuster 30, and causes the focus adjuster 30 to set the focus position.

In step S106, when the processing circuit 62 stores information on the focus position for the irradiation point 12 in the memory 64, the processing circuit 62 may obtain, from the memory 64, information on the focus position for the immediately preceding irradiation point 12, and may obtain information on a lens position corresponding to the focus position from the table illustrated in FIG. 2A. Since the information on the focus position for the irradiation point 12 is stored in the memory 64, the information can be easily obtained.

The processing circuit 62 repeats the operations of irradiation and distance measurement in the order of steps S104 to S107, S108, S102, and S109 until all irradiation points 12 are measured. After all irradiation points 12 are measured, the processing circuit 62 completes the measurement operation.

When multiple irradiation points 12 are numbered in the irradiation order, the above-described measurement operation includes an operation for setting the focus position for the ith (i≥2) irradiation point 12 based on the distance to the (i−1)th irradiation point 12. The focus position for the ith irradiation point 12 is not an optimal focus position for the irradiation point 12 in a strict sense, but is substantially an optimal focus position. This is because the ith irradiation point 12 on the object 10 is located in the vicinity of the (i−1)th position, thus change in the distance, in other words, change in the focus position is small. When the change in the focus position is smaller than the range of the depth of focus of the lens, the change in the light detection intensity is small, thus distance measurement is possible in a sufficiently stable manner.

Thus, in Example 1 of measurement operation, after the focus position for the irradiation point 12 to be measured subsequently is determined based on the distance to the immediately preceding irradiation point 12 located in the vicinity of the subsequent irradiation point 12, the distance to the irradiation point 12 is measured. In Example 1 of measurement operation, a common configuration is used in the operation for focus position determination and the operation for distance measurement. Therefore, in the measuring apparatuses 100A to 100C according to the exemplary embodiment, distance information of the irradiation point 12 on the object 10 can be accurately generated using a simple configuration.

### Focus Position Adjustment Operation for First Irradiation Point 12

As described in step S103, when the irradiation point 12 is the first point, the processing circuit 62 has not obtained information on the optimal focus position for the irradiation point 12. Therefore, for the first point, the focus position needs to be adjusted and determined in one way or another.

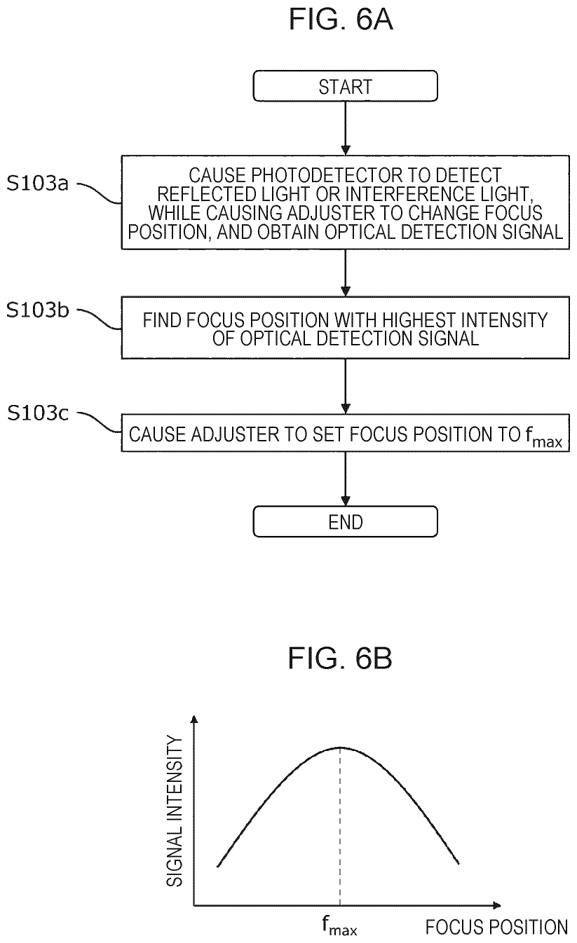

Multiple methods for adjusting the focus position are publicly known, and one example will be described with reference to FIGS. 6A and 6B. FIG. 6A is a flowchart schematically illustrating an example of a focus position adjustment operation performed by the processing circuit 62 in the measuring apparatuses 100A to 100C according to the exemplary embodiment. The processing circuit 62 performs the operation in steps S103a to S103c illustrated in FIG. 6A.

### Step S103a

The processing circuit 62 causes the photodetector 50 to detect the reflected light 20Lb or the interference light 20L2, while causing the focus adjuster 30 to change the focus position continuously or stepwise, and obtains an optical detection signal outputted from the photodetector 50.

### Step S103b

The processing circuit 62 finds a focus position with the highest intensity of the optical detection signal from the relationship between the focus position and the intensity of the optical detection signal. FIG. 6B is a graph illustrating a relationship between the focus position and the intensity of the optical detection signal. In this graph, when the focus position is fₘₐₓ, the intensity of the optical detection signal is the highest. Therefore, it is found that the optimal focus position is fₘₐₓ, at which the spot size of the irradiation light 20La is minimized for the irradiation point 12. In this manner, an optimal focus position is determined. However, a relative error of less than or equal to 3% between the determined focus position and the optimal focus position is allowed. The relative error is the quotient when the absolute value of the difference between the determined focus position and the optimal focus position is divided by the optimal focus position.

### Step S103c

The processing circuit 62 causes the focus adjuster 30 to set the focus position to the determined optimal focus position fₘₐₓ.

### Example 2 of Measurement Operation

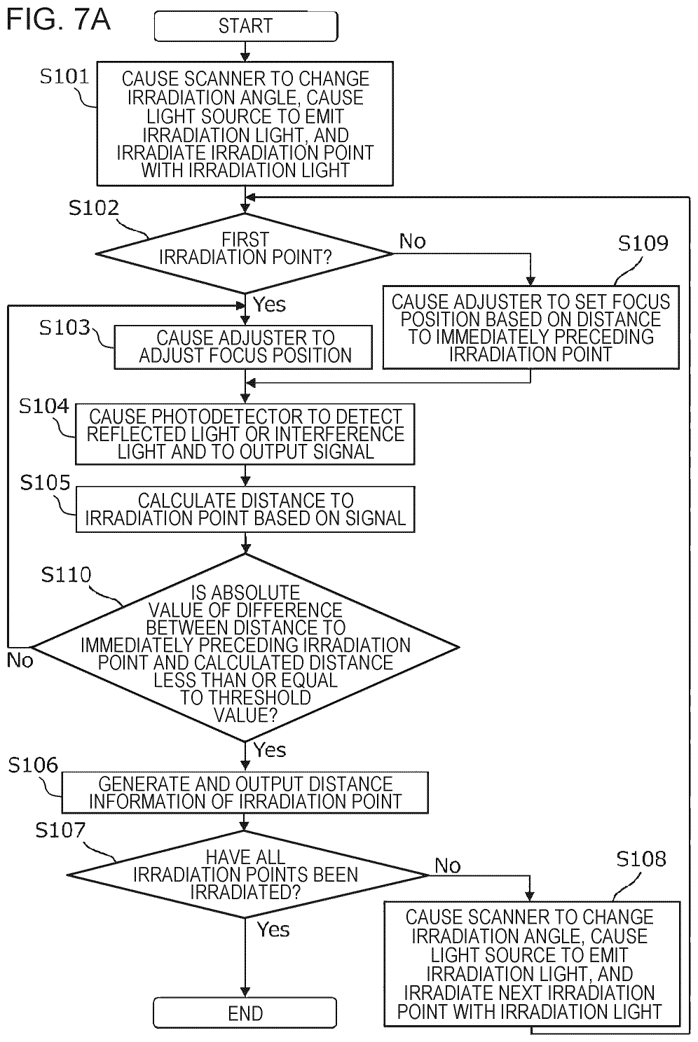

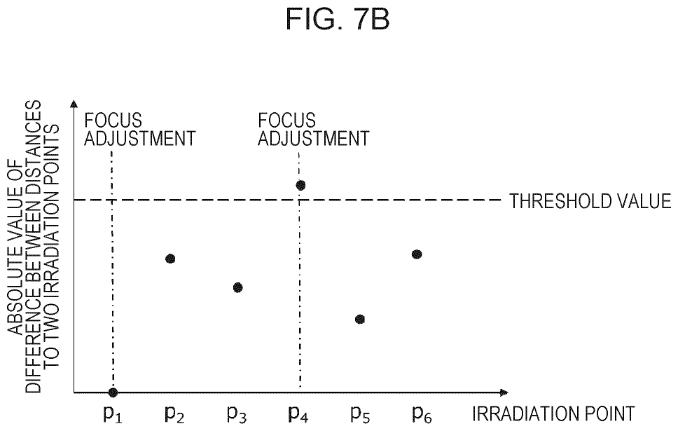

Next, Example 2 of measurement operation performed by the measuring apparatuses 100A to 100C for measuring the shape of the object 10 according to the exemplary embodiment will be described with reference to FIGS. 7A and 7B. FIG. 7A is a flowchart schematically illustrating Example 2 of measurement operation performed by the processing circuit 62 in the measuring apparatuses 100A to 100C according to the exemplary embodiment. The processing circuit 62 performs the operation in steps S101 to S110 illustrated in FIG. 7A. The flowchart illustrated in FIG. 7A is different from the flowchart illustrated in FIG. 5, and includes step S110 between step S105 and step S106.

### Step S110

When the irradiation point 12 is not the first point, the processing circuit 62 determines whether the absolute value of the difference between the distance to the immediately preceding irradiation point 12 with the focus position determined and the distance calculated in step S105 is less than or equal to a predetermined threshold value. When the determination is Yes, the processing circuit 62 performs the operation in step S106. When the determination is No, the processing circuit 62 performs the operation in step S103 again to adjust the focus position for the irradiation point 12 to be measured subsequently. For example, this method for adjusting the focus position may be the same as the method for adjusting the focus position for the first irradiation point.

Let multiple irradiation points 12 be irradiation points p₁ to p₆. FIG. 7B is a graph when the irradiation points p₁ to p₆ are sequentially irradiated, the graph schematically illustrating an example of a relationship between the irradiation points p₁ to p₆ and the absolute value of the difference between the distance to each irradiation point and the distance to the immediately preceding irradiation point. The irradiation angle of each of the irradiation points p₁ to p₆ increases or decreases for a larger subscript number. The absolute value of the difference between the distance to each irradiation point and the distance to the immediately preceding irradiation point is referred to as the “absolute value of the difference in the distances to two irradiation points”.

In the example illustrated in FIG. 7B, the focus position is adjusted at the first irradiation point p₁, and the focus position is set to an optimal focus position. At the irradiation point p₂, the irradiation point p₃, the irradiation point p₅, and the irradiation point p₆, the absolute value of the difference in the distances to two irradiation points is less than or equal to a predetermined threshold value. Therefore, at the irradiation point p₂, the irradiation point p₃, the irradiation point p₅, and the irradiation point p₆, the focus position is set based on the distance to the irradiation point p₁, to the irradiation point p₂, to the irradiation point p₄, and to the irradiation point p₅ which are respectively immediately preceding irradiation points.

Meanwhile, at the irradiation point p₄, the absolute value of the difference in the distances to two irradiation points exceeds a predetermined threshold value. Therefore, at the irradiation point p₄, the focus position is adjusted in step S103, and the focus position is set to an optimal focus position, then the distance to the irradiation point p₄ is calculated again in step S105. In step S110, the absolute value of the difference in the distances to the two irradiation points is less than or equal to the predetermined threshold value, thus distance information of the irradiation point p₄ is generated and output in step S106.

In the above-described measurement operation, even when the shape of the object 10 is rough, the focus position can be appropriately set according to the shape. Therefore, accurate distance measurement is possible.

Note that the above-described determination may be made using the absolute value of the difference between the intensity of the optical detection signal for each irradiation point and the intensity of the optical detection signal for the immediately preceding irradiation point instead of using the absolute value of the difference between the distance to each irradiation point and the distance to the immediately preceding irradiation point.

### Example 3 of Measurement Operation

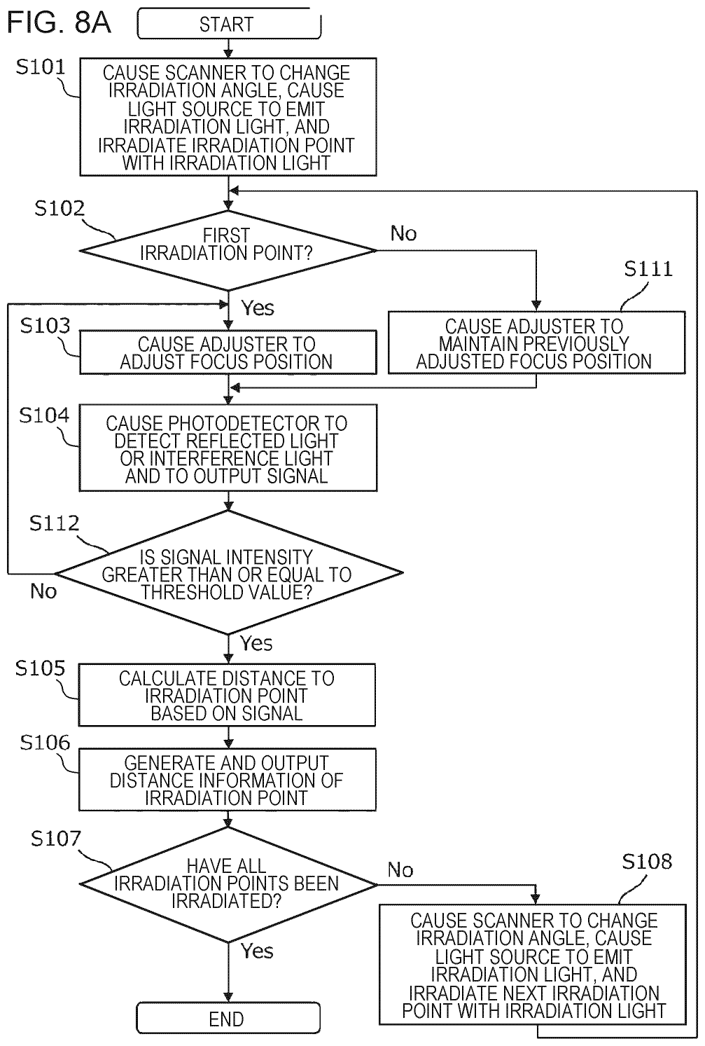

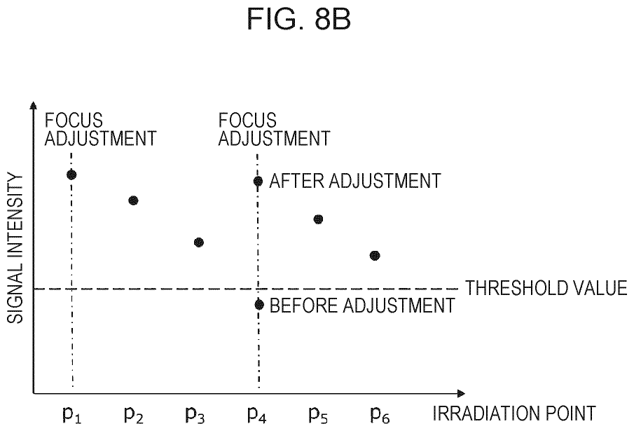

Next, Example 3 of measurement operation performed by the measuring apparatuses 100A to 100C for measuring the shape of the object 10 according to the exemplary embodiment will be described with reference to FIGS. 8A and 8B. In this measurement operation, the intensity of the optical detection signal is used as the optical detection information. FIG. 8A is a flowchart schematically illustrating Example 3 of measurement operation performed by the processing circuit 62 in the measuring apparatuses 100A to 100C according to the exemplary embodiment. The processing circuit 62 performs the operation in steps S101 to S108, S111, and S112 illustrated in FIG. 8A. The flowchart illustrated in FIG. 8A is different from the flowchart illustrated in FIG. 5, and includes step S111 instead of step S109, and step S112 between step S104 and step S105.

### Step S111

After the focus position for the first irradiation point 12 is adjusted and the distance thereto is measured, for the second and subsequent irradiation points, the processing circuit 62 causes the focus adjuster 30 to maintain the previously adjusted focus position. During the period since the start of the measurement operation until the operation in step S103 is performed again, the previously adjusted focus position is the focus position for the first irradiation point 12.

### Step S112

The processing circuit 62 determines whether the intensity of the optical detection signal outputted from the photodetector 50 in step S104 is greater than or equal to a predetermined threshold value. When the determination is Yes, the processing circuit 62 performs the operation in step S105. When the determination is No, the processing circuit 62 performs the operation in step S103 again to adjust the focus position for the irradiation point 12 to be measured subsequently. For example, this method for adjusting the focus position may be the same as the method for adjusting the focus position for the first irradiation point.

Let multiple irradiation points 12 be irradiation points p₁ to p₆. FIG. 8B is a graph when the irradiation points p₁ to p₆ are sequentially irradiated, the graph schematically illustrating an example of a relationship between the irradiation points p₁ to p₆ and the intensity of the optical detection signal. The irradiation angle of each of the irradiation points p₁ to p₆ increases or decreases for a larger subscript number. In the example illustrated in FIG. 8B, the focus position is adjusted at the first irradiation point p₁, and the focus position is set to an optimal focus position. At the irradiation point p₂ and the irradiation point p₃, the intensity of the optical detection signal is greater than or equal to a predetermined threshold value. Therefore, at the irradiation point p₂ and the irradiation point p₃, distance measurement is performed while maintaining the previously adjusted focus position for the irradiation point p₁.

In contrast, at the irradiation point p₄, the intensity of the optical detection signal falls below a predetermined threshold value. Therefore, at the irradiation point p₄, the focus position is adjusted in step S103, and the focus position is set to an optimal focus position. In step S112, the intensity of the optical detection signal is greater than or equal to a threshold value, thus in step S105, the distance to the irradiation point p₄ is calculated again, and in step S106, distance information of the irradiation point p₄ is generated and output. At the irradiation point p₅ and the irradiation point p₆, the intensity of the optical detection signal is greater than or equal to a predetermined threshold value. Therefore, at the irradiation point p₅ and the irradiation point p₆, distance measurement is performed while maintaining the previously adjusted focus position for the irradiation point p₄.

In the above-described measurement operation, the focus position can be appropriately set without performing an operation of storing the distance to the immediately preceding irradiation point and retrieving the distance. Therefore, accurate and efficient distance measurement is made possible. In the above-described measurement operation, when the shape of the object 10 is not rough, in other words, when the shape of the object 10 is relatively flat, a particularly significant effect is obtained.

Thus, in Example 3 of measurement operation, after the focus position for the irradiation point 12 to be measured subsequently is determined based on the intensity of the optical detection signal for an irradiation point 12 located in the vicinity of the subsequent irradiation point 12, the distance to the irradiation point 12 is measured. As in Examples 1 and 2 of measurement operation, in Example 3 of measurement operation, a common configuration is used in the operation for focus position determination and the operation for distance measurement. Therefore, in the measuring apparatuses 100A to 100C according to the exemplary embodiment, distance information of the irradiation point 12 on the object 10 can be accurately generated using a simple configuration.

### Example 4 of Measurement Operation

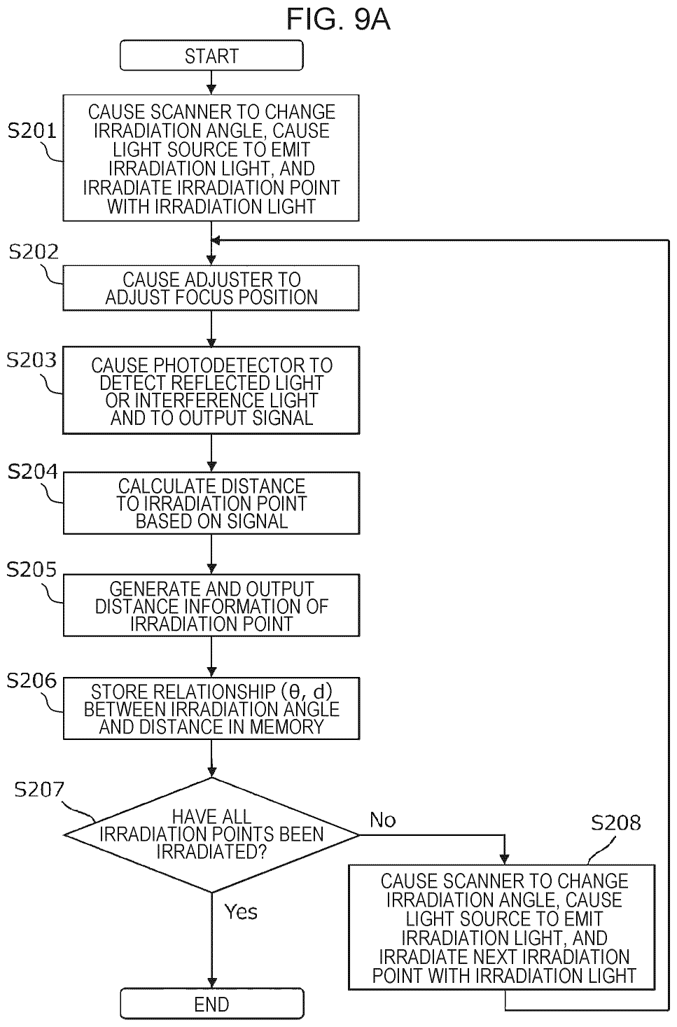

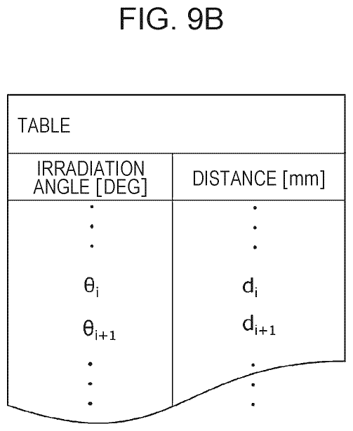

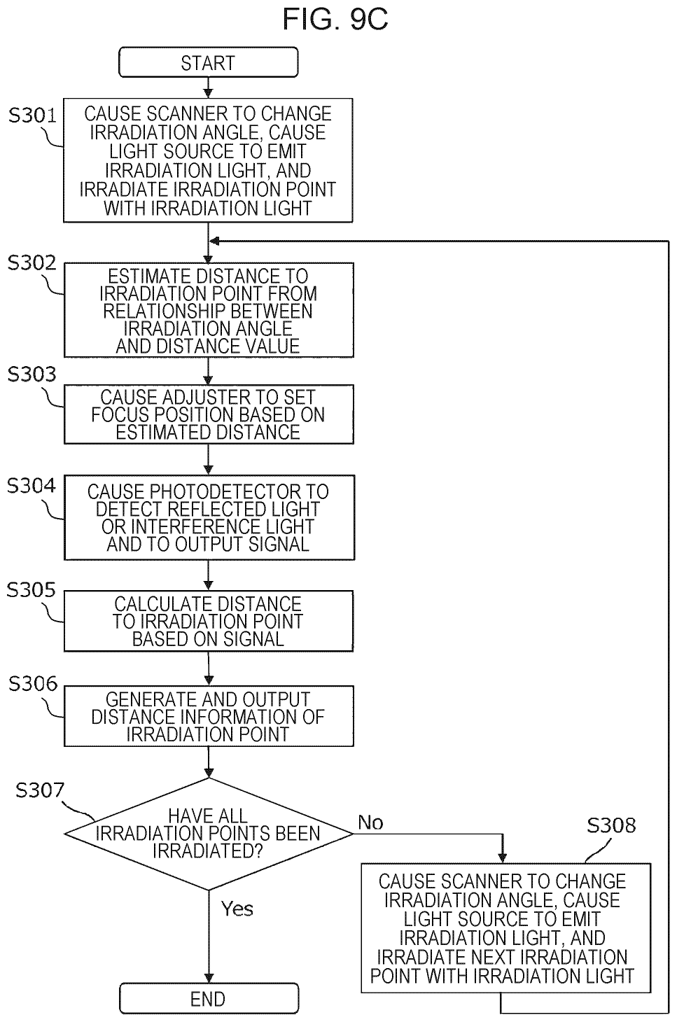

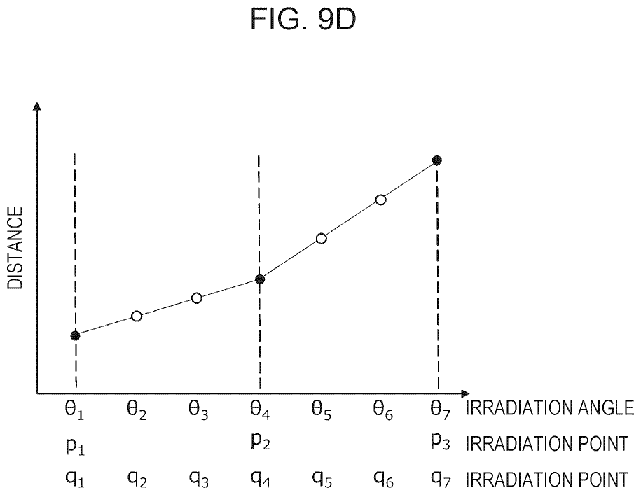

Next, Example 4 of measurement operation performed by the measuring apparatuses 100A to 100C for measuring the shape of the object 10 according to the exemplary embodiment will be described with reference to FIGS. 9A to 9D. In this example, the measurement operation includes a first scan operation and a second scan operation. In the first scan operation, n₁ irradiation points on the object 10 are measured. In the second scan operation, n₂ irradiation points on the object 10 are measured. n₁ is not necessarily the same as n₂, and n₁ may be smaller than n₂. The range of distribution of multiple irradiation points in the first scan operation may be included in the range of distribution of multiple irradiation points in the second scan operation. All the multiple irradiation points in the first scan operation may be included in the multiple irradiation points in the second scan operation. The change in the irradiation angle in the first scan operation may be greater than the change in the irradiation angle in the second scan operation.

In the following description, the irradiation points p₁ to p₃ are measured in the first scan operation, and the irradiation points q₁ to q₇ are measured in the second scan operation. Table 1 shows a corresponding relationship between the irradiation points p₁ to p₃, the irradiation points q₁ to q₇, and irradiation angles θ₁ to θ₇. The irradiation angles θ₁ to θ₇ each increase or decrease for a larger subscript number.

TABLE 1

| | | | | | | | |
|---|---|---|---|---|---|---|---|
| Irradiation Points in | p₁ | | | p₂ | | | p₃ |
| First Scan Operation | | | | | | | |
| Irradiation Points in | q₁ | q₂ | q₃ | q₄ | q₅ | q₆ | q₇ |
| Second Scan Operation | | | | | | | |
| Irradiation Angle | θ₁ | θ₂ | θ₃ | θ₄ | θ₅ | θ₆ | θ₇ |

The irradiation point q₁, the irradiation point q₄, and the irradiation point q₇ in the second scan operation respectively match the irradiation point p₁, the irradiation point p₂, and the irradiation point p₃ in the first scan operation. The irradiation point q₂ and the irradiation point q₃ in the second scan operation are located between the irradiation point p₁ and the irradiation point p₂ in the first scan operation. The irradiation point q₅ and the irradiation point q₆ in the second scan operation are located between the irradiation point p₂ and the irradiation point p₃ in the first scan operation. Note that the number of the irradiation points in the first scan operation and the number of the irradiation points in the second scan operation are not limited to the above examples, and may be any number.

FIG. 9A is a flowchart schematically illustrating the first scan operation in Example 4 of measurement operation performed by the processing circuit 62 in the measuring apparatuses 100A to 100C according to the exemplary embodiment. The processing circuit 62 performs the operations in steps S201 to S208 illustrated in FIG. 9A for the irradiation points p₁ to p₃.

### Steps S201 to S205

The operations in steps S201 to S205 are respectively the same as the operations in step S101, S103 to S106 illustrated in FIG. 5.

### Step S206

The processing circuit 62 stores, in the memory 64, a table showing a relationship between the irradiation angle θ and the distance d. Instead of the distance d, the focus position or the lens position may be used.

### Steps S207 and S208

The operations in step S207 and S208 are respectively the same as the operations in step S107 and S108 illustrated in FIG. 5.

The processing circuit 62 repeats the operations in step S202 to S208 until all irradiation points are irradiated. After all irradiation points are irradiated, the processing circuit 62 completes the first scan operation. In the first scan operation, for all the irradiation points p₁ to p₃, the focus position is adjusted in step S202, and the focus position is set to an optimal focus position.

A table showing a relationship between the irradiation angle θ and the distance d is generated by the first scan operation. FIG. 9B is a chart schematically illustrating a table showing a relationship between the irradiation angle θ and the distance d generated in the first scan operation. The table illustrated in FIG. 9B is used in the second scan operation.

FIG. 9C is a flowchart schematically illustrating the second scan operation in Example 4 of measurement operation performed by the processing circuit 62 in the measuring apparatuses 100A to 100C according to the exemplary embodiment. The processing circuit 62 performs the operations in steps S301 to S308 illustrated in FIG. 9C for the irradiation points q₁ to q₇.

### Step S301

The operation in step S301 is the same as the operation in step S101 illustrated in FIG. 5.

### Step S302

From the relationship, stored in the first scan operation, between the irradiation angle θ and the distance d, the processing circuit 62 estimates the distance to an irradiation point not matching any of the irradiation points p₁ to p₃ in the first scan operation, the irradiation point being among the irradiation points q₁ to q₇ in the second scan operation. Of the irradiation points q₁ to q₇ in the second scan operation, for an irradiation point matching one of the irradiation points p₁ to p₃ in the first scan operation, the distance to the one irradiation point can be used.

FIG. 9D is a graph schematically illustrating an example of a relationship between the irradiation point and the distance in the first and second scan operations. The solid black circles illustrated in FIG. 9D each indicate a measured distance to the irradiation point p₁, to the irradiation point p₂, or to the irradiation point p₃ in the first scan operation. The solid black circles are plotted based on the table illustrated in FIG. 9B. The open circles illustrated in FIG. 9D each indicate an estimated distance to the irradiation point q₂, to the irradiation point q₃, to the irradiation point q₅, or to the irradiation point q₆ in the second scan operation. The method for estimating a distance is as follows.

Since the distances to the irradiation point q₁, to the irradiation point q₄, and to the irradiation point q₇ are known, the distances to the irradiation point q₂, to the irradiation point q₃, to the irradiation point q₅, and to the irradiation point q₆ can be calculated by interpolation based on the known distances using the irradiation angle as a variable. As the interpolation, e.g., a linear interpolation is used.

When the range of distribution of multiple irradiation points in the second scan operation is greater than the range of distribution of multiple irradiation points in the first scan operation, approximate distances to the multiple irradiation points in the second scan operation may be calculated by extrapolation based on the known distances using the irradiation angle as a variable. As the extrapolation, e.g., a linear interpolation is used.

The distances to the irradiation point q₂, to the irradiation point q₃, to the irradiation point q₅, and to the irradiation point q₆ may be estimated by another method other than the method described above.

When an irradiation point in the second scan operation does not match any of the known irradiation points in the first scan operation, and is located in the vicinity of a known irradiation point in the first scan operation, the distance to the irradiation point in the second scan operation can be accurately estimated.

When the number of irradiation points in the first scan operation is less than the number of irradiation points in the second scan operation, the number of times of operation of adjusting the focus position in the first scan operation can be reduced, and the distances to even more irradiation points can be measured in a short time in the second scan operation.

### Step S303

The processing circuit 62 causes the focus adjuster 30 to set the focus position based on the estimated distance.

### Steps S304 to S308

The operations in steps S304 to S308 are respectively the same as the operations in steps S104 to S108 illustrated in FIG. 5.

The processing circuit 62 repeats the operations in steps S302 to S308 until all irradiation points are irradiated. After all irradiation points are irradiated, the processing circuit 62 completes the second scan operation.

Thus, in Example 4 of measurement operation, after the focus position for the irradiation point 12 to be measured subsequently is determined based on the distance to an irradiation point 12 located in the vicinity of the subsequent irradiation point 12, the distance to the irradiation point 12 is measured. The irradiation point 12 to be measured subsequently is an irradiation point 12 in the second scan operation, and the irradiation point 12 located in the vicinity is an irradiation point 12 in the first scan operation. As in Examples 1 to 3 of measurement operation, in Example 4 of measurement operation, a common configuration is used in the operation for focus position determination and the operation for distance measurement. Therefore, in the measuring apparatuses 100A to 100C according to the exemplary embodiment, distance information of the irradiation point 12 on the object 10 can be accurately generated using a simple configuration.

### Summary of Examples 1 to 4 of Measurement Operation

In Examples 1 to 4 of measurement operation for generating distance information of multiple irradiation points 12, the processing circuit 62 performs the following operations (A) to (E). As illustrated in FIG. 1A, the multiple irradiation points 12 include a first irradiation point 12a and a second irradiation point 12b. The second irradiation point 12b is located in the vicinity of the first irradiation point 12a.
(A) The first irradiation point 12a on the object 10 is irradiated with irradiation light 20La by causing the scanner 40 to change the irradiation angle, and causing the light source 20 to emit the irradiation light 20La. However, when the irradiation point is the first point, the processing circuit 62 does not need to cause the scanner 40 to change the irradiation angle.
(B) Optical detection information of the first irradiation point 12a is generated based on the reflected light 20Lb from the first irradiation point 12a detected by the photodetector 50. In the present specification, the reflected light 20Lb from the first irradiation point 12a is also referred to as the “first reflected light”.
(C) The focus adjuster 30 is caused to set the focus position of the irradiation light 20La based on the optical detection information.
(D) The second irradiation point 12b on the object 10 is irradiated with the irradiation light 20La by causing the scanner 40 to change the irradiation angle, and causing the light source 20 to emit the irradiation light 20La.
(E) Distance information of the second irradiation point 12b is generated based on the reflected light 20Lb from the second irradiation point 12b detected by the photodetector 50. In the present specification, the reflected light 20Lb from the second irradiation point 12b is also referred to as the “second reflected light”.

In Examples 1 to 4 of measurement operation, the optical detection information may be e.g., information on the focus position of the irradiation light 20La for the first irradiation point 12a, information on the intensity of the reflected light 20Lb from the first irradiation point 12a, or distance information of the first irradiation point 12a.

In Examples 1 and 2 of measurement operation, the processing circuit 62 causes the scanner 40 to change the irradiation angle, causes the light source 20 to emit the irradiation light 20La, and sequentially irradiates multiple irradiation points 12 on the object 10 with the irradiation light 20La. The multiple irradiation points 12 are m (m≥2) irradiation points 12. When the m irradiation points 12 are numbered in the irradiation order, the first irradiation point 12a is the (i−1)th (2≤i≤m) irradiation point, and the second irradiation point 12b is the ith irradiation point.

In Example 2 of measurement operation, when the absolute value of the difference between the distance to the (i−1)th irradiation point 12 and the distance to the ith irradiation point 12 exceeds a predetermined threshold value, the processing circuit 62 causes the focus adjuster 30 to adjust the focus position of the irradiation light 20La for irradiating the ith irradiation point. In the example illustrated in FIG. 7B, the ith irradiation point is the irradiation point p₄.

In Example 3 of measurement operation, the processing circuit 62 causes the scanner 40 to change the irradiation angle, causes the light source 20 to emit the irradiation light 20La, and sequentially irradiates multiple irradiation points 12 on the object 10 with the irradiation light 20La. The multiple irradiation points 12 are m (m≥2) irradiation points 12. The first irradiation point 12a is the (i-p)th (2≤i≤m, 1≤p≤i−1) irradiation point, and the second irradiation point 12b is the ith irradiation point. In the example illustrated in FIG. 8B, the (i-p)th irradiation point is the irradiation point p₁, and the ith irradiation point is the irradiation point p₂ or the irradiation point p₃. Or the (i-p) th irradiation point is the irradiation point p₄, and the ith irradiation point is the irradiation point p₅ or the irradiation point p₆.

In Example 3 of measurement operation, when the intensity of the optical detection signal for the ith irradiation point falls below a predetermined threshold value, the processing circuit 62 causes the focus adjuster 30 to adjust the focus position of the irradiation light 20La for irradiating the ith irradiation point. In the example illustrated in FIG. 8B, the ith irradiation point is the irradiation point p₄.

In Example 4 of measurement operation, the processing circuit 62 causes the scanner 40 to change the irradiation angle, causes the light source 20 to emit the irradiation light 20La, and performs the first scan operation for sequentially irradiating n₁ irradiation points 12 on the object 10 with the irradiation light 20La. Similarly, the processing circuit 62 causes the scanner 40 to change the irradiation angle, causes the light source 20 to emit the irradiation light 20La, and performs the second scan operation for sequentially irradiating n₂ irradiation points 12 on the object 10 with the irradiation light 20La. The first irradiation point 12a is the jth (1≤j≤n₁) irradiation point in the first scan operation, and the second irradiation point 12b is the kth (1≤k≤n₂) irradiation point in the second scan operation. The kth irradiation point is located in the vicinity of the jth irradiation point. n₁ may be smaller than n₂.

In Examples 1 and 2 of measurement operation, the processing circuit 62 causes the focus adjuster 30 to set the focus position based on the distance to the immediately preceding irradiation point, but the operation is not limited to this. The processing circuit 62 may cause the focus adjuster 30 to set the focus position based on the distance to a preceding irradiation point.

In Examples 1 to 4 of measurement operation, the processing circuit 62 sends a control signal including information on the irradiation angle to the scanner 40, and causes the scanner 40 to set the irradiation angle to a predetermined value, but the operation is not limited to this. Conversely, the scanner 40 may send a signal including information on the irradiation angle to the processing circuit 62, which may measure the distance to the irradiation point 12 at a timing when the irradiation angle matches a predetermined value.

In Examples 1 to 4 of measurement operation, the processing circuit 62 outputs distance information of an irradiation point each time the irradiation point is measured, but the operation is not limited to this. After the measurement operation for all the multiple irradiation points is completed, the processing circuit 62 may output distance information of the multiple irradiation points. When the distance information of the multiple irradiation points is output to another apparatus in this manner, it is advantageous that processing in another apparatus can be simplified because the distance information of the multiple irradiation points does not need to be integrated in another apparatus at an output destination.

In Examples 1 to 4 of measurement operation, two-dimensional scan may be used instead of one-dimensional scan.

### EXAMPLES

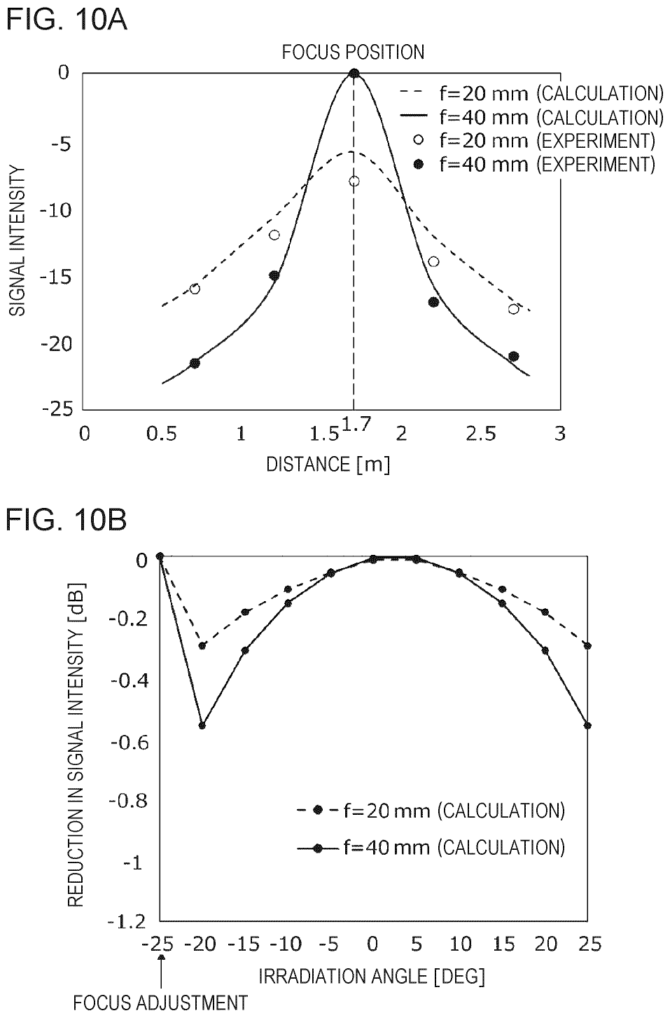

The result of experiment and the result of calculation conducted to verify the effect obtained by the measuring apparatus according to the exemplary embodiment will be described below with reference to FIGS. 10A and 10B. In the experiment, the measuring apparatus 100C illustrated in FIG. 3B was used. The measuring apparatus 100C adopting a coaxial optical system utilizes the FMCW-LiDAR technique.

First, the relationship between the distance to irradiation point 12 on the object 10 and the intensity of the optical detection signal has been studied. However, the distance to the irradiation point 12 corresponds to the total of the distance d and the distance fa in the example illustrated in FIG. 1B.

In the experiment and the calculation, as the lens 34 of the focus adjuster 30, a collimator lens was used, which can converge and diverge the irradiation light 20La. When the collimator lens is moved parallel to the optical axis, the laser beam achieves a converged state or a diverged state at a certain point on the optical axis. When the focus position is located forward of the certain point, the laser beam achieves a converged state at the certain point. On the other hand, when the focus position is located rearward of the certain point, the laser beam achieves a diverged state at the certain point.

As the lens 34, two types of collimator lens having focal lengths f=20 mm and f=40 mm were used, and the focus position was set to 1.7 m. The object 10 was a white planar diffuser plate. In the experiment, the intensity of the optical detection signal was measured with the focus position maintained while changing the distance to the irradiation point 12 by bringing the object 10 closer to the measuring apparatus 100C or moving the object 10 away from the measuring apparatus 100C. The signal intensity was normalized such that 0 dB occurs when the focal length of the lens 34 is f=40 mm, and the distance to the irradiation point 12 is 1.7 m.

FIG. 10A is a graph illustrating a relationship between the distance to irradiation point 12 and the intensity of the optical detection signal. The solid curve and dashed curve illustrated in FIG. 10A indicate calculation results when the focal length of the lens 34 is f=40 mm and f=20 mm, respectively. The solid black circles and open circles illustrated in FIG. 10A indicate experimental results when the focal length of the lens 34 is f=40 mm and f=20 mm, respectively. As illustrated in FIG. 10A, the calculation results and the experimental results generally agree with each other.

As illustrated in FIG. 10A, the intensity of the optical detection signal is highest when the focus position of the irradiation light 20La is the same as the distance to the irradiation point 12. Therefore, accurate distance measurement is possible by adjusting the focus position closer to the distance to the irradiation point 12.

As illustrated in FIG. 10A, the highest value of the intensity of the optical detection signal can be further increased with the lens 34 having f=40 mm than with the lens 34 having f=20 mm. Therefore, with a longer focal length, the intensity of the optical detection signal can be increased even if the intensity of the reflected light 20Lb is low.

On the other hand, as illustrated in FIG. 10A, change in the signal intensity for the distance can be made more gradual with the lens 34 having f=20 mm than with the lens 34 having f=40 mm. Therefore, with a shorter focal length, deterioration of the signal intensity can be reduced even if the focus position deviates from an optimal focus position.

Next, in Example 1 of the measurement operation described above, it was studied to what extent the signal intensity is reduced, using the calculation result illustrated in FIG. 10A. The range of the irradiation angle was set to greater than or equal to −25 degrees and less than or equal to 25 degrees, and the distance to the object 10 with 0 degree of the irradiation angle was set to 1.7 m. The irradiation angle was changed with an increment of 5 degrees, and multiple irradiation points were sequentially irradiated. The irradiation angle of the first irradiation point was −25 degrees, and the focus position was adjusted only for the first point. The focus position of the second and subsequent irradiation points is set based on the distance value of the immediately preceding irradiation point, in other words, the irradiation point having an irradiation angle different from the current angle by −5 degrees.

FIG. 10B is a graph illustrating a relationship between irradiation angle and reduction in signal intensity. The reduction in the signal intensity is the absolute value of the difference between the following two signal intensities. One of the signal intensities is the intensity of the optical detection signal when the focus position is set at an optimal focus position. The other signal intensity is the intensity of the optical detection signal when the focus position is set based on the distance to the immediately preceding irradiation point. As illustrated in FIG. 10B, the reduction in the signal intensity increases as the absolute value of the irradiation angle increases, but the reduction in the signal intensity is approximately −0.6 dB even for the lens 34 having f=40 mm. In general, the optical detection signal has a S/N of 10 to several tens dB, thus a reduction in the signal intensity in this order probably has almost no effect on the result of distance measurement.

Therefore, as explained in Examples 1 to 4 of measurement operation, setting the focus position for the irradiation point 12 based on the distance to an irradiation point located in the vicinity of the irradiation point 12 can be an effective method in that the focus position can be determined and accurate distance measurement is made possible using a simple configuration.

### Appendix

The following techniques are disclosed in the description of the exemplary embodiments above.

### Technique 1

A measuring apparatus comprising:
a light source that emits irradiation light for irradiating an object;
an adjuster that adjusts a focus position of the irradiation light;
a scanner that changes an irradiation angle of the irradiation light;
a photodetector that detects reflected light from the object and outputs a signal; and
a processing circuit that controls the light source, the adjuster, and the scanner, and that processes the signal outputted from the photodetector.

The processing circuit causes the light source to emit the irradiation light to irradiate a first irradiation point on the object with the irradiation light,
generates optical detection information of the first irradiation point based on first reflected light from the first irradiation point, detected by the photodetector,
causes the adjuster to set the focus position of the irradiation light based on the optical detection information,
causes the scanner to change the irradiation angle, and causes the light source to emit the irradiation light to irradiate a second irradiation point on the object with the irradiation light, and
generates distance information of the second irradiation point based on second reflected light from the second irradiation point, detected by the photodetector.

The measuring apparatus can accurately generate distance information of an irradiation point on an object using a simple configuration.

### Technique 2

The measuring apparatus according to Technique 1,
wherein the second irradiation point is located in a vicinity of the first irradiation point.

The measuring apparatus can accurately generate distance information of the second irradiation point using the focus position set based on the optical detection information of the first irradiation point.

### Technique 3

The measuring apparatus according to Technique 2,
wherein an absolute value of a difference between the irradiation angle for the second irradiation point and the irradiation angle for the first irradiation point is less than or equal to 10 degrees.

The measuring apparatus can accurately generate distance information of the second irradiation point using the focus position set based on the optical detection information of the first irradiation point.

### Technique 4

The measuring apparatus according to any one of Techniques 1 to 3,
wherein the optical detection information is information on the focus position of the irradiation light for the first irradiation point, information on the intensity of the first reflected light, or distance information of the first irradiation point.

The measuring apparatus can set the focus position based on the aforementioned information.

### Technique 5

The measuring apparatus according to any one of Techniques 1 to 4,
wherein the adjuster is caused to set the focus position of the irradiation light for the first irradiation point so that an optical detection signal at the first irradiation point has a highest intensity.

The measuring apparatus can accurately generate distance information of the second irradiation point using the focus position set as described above.

### Technique 6

The measuring apparatus according to any one of Techniques 1 to 5, further comprising
a memory that stores the optical detection information,
wherein the processing circuit obtains the optical detection information from the memory, and causes the adjuster to set the focus position of the irradiation light based on the obtained optical detection information.

The measuring apparatus facilitates acquisition of the optical detection information.

### Technique 7

The measuring apparatus according to any one of Techniques 1 to 6,
wherein the processing circuit causes the scanner to change the irradiation angle, and causes the light source to emit the irradiation light to irradiate m (m≥2) irradiation points on the object with the irradiation light, and
the first irradiation point is the (i−1) th (2≤i≤m) irradiation point, and the second irradiation point is the ith irradiation point.

The measuring apparatus can accurately generate distance information of the irradiation point to be subsequently irradiated, using the focus position set based on the optical detection information of the irradiation point irradiated immediately before.

### Technique 8

The measuring apparatus according to Technique 7,
wherein when an absolute value of a difference between a distance to the (i−1)th irradiation point and a distance to the ith irradiation point exceeds a predetermined threshold value, the processing circuit causes the adjuster to adjust the focus position of the irradiation light for irradiating the ith irradiation point.

The measuring apparatus can set the focus position for the ith irradiation point to an optimal focus position.

### Technique 9

The measuring apparatus according to any one of Techniques 1 to 6,
wherein the processing circuit causes the scanner to change the irradiation angle, and causes the light source to emit the irradiation light to sequentially irradiate m (m≥2) irradiation points on the object with the irradiation light, and
the first irradiation point is the (i-p)th (2≤i≤m, 1≤p≤i−1) irradiation point, and the second irradiation point is the ith irradiation point.

The measuring apparatus can accurately generate distance information of the irradiation point to be subsequently irradiated, using the focus position set based on the optical detection information of the irradiation point irradiated immediately before or several steps before.

### Technique 10

The measuring apparatus according to Techniques 9,
wherein when an intensity of an optical detection signal for the ith irradiation point falls below a predetermined threshold value, the processing circuit causes the adjuster to adjust the focus position of the irradiation light for irradiating the ith irradiation point.

The measuring apparatus can set the focus position for the ith irradiation point to an optimal focus position.

### Technique 11

The measuring apparatus according to any one of Techniques 1 to 6,
wherein the processing circuit performs a first scan operation by causing the scanner to change the irradiation angle, causing the light source to emit the irradiation light, and sequentially irradiating n₁ irradiation points on the object with the irradiation light, and
performs a second scan operation by causing the scanner to change the irradiation angle, causing the light source to emit the irradiation light, and sequentially irradiating n₂ irradiation points on the object with the irradiation light,
the first irradiation point being the jth (1≤j≤n₁) irradiation point in the first scan operation,
the second irradiation point being the kth (1≤k≤n₂) irradiation point in the second scan operation.

The measuring apparatus can accurately generate distance information of the irradiation points in the second scan operation based on the information obtained by the first scan operation.

### Technique 12

The measuring apparatus according to Technique 11,
wherein n₁ is smaller than n₂.

The measuring apparatus can reduce the number of times of operation of adjusting the focus position in the first scan operation, and can measure the distances to even more irradiation points in a short time in the second scan operation.

### Technique 13

The measuring apparatus according to any one of Techniques 1 to 12, further comprising
an optical element that emits the irradiation light, and receives the reflected light to input the reflected light to the photodetector.

In the measuring apparatus, the configuration of the measuring apparatus can be simplified, and stable measurement can be achieved.

### Technique 14

The measuring apparatus according to any one of Techniques 1 to 13,
wherein after completing a measurement operation for all multiple irradiation points including the first irradiation point and the second irradiation point, the processing circuit outputs distance information of the multiple irradiation points.

In the measuring apparatus, when the distance information of the multiple irradiation points is output to another apparatus as described above, the processing in another apparatus can be simplified because the distance information of the multiple irradiation points does not need to be integrated in another apparatus at an output destination.

### Technique 15

A measuring apparatus comprising:
a light source that emits irradiation light for irradiating an object;
an adjuster that adjusts a focus position of the irradiation light;
a scanner that changes an irradiation angle of the irradiation light;
a photodetector that detects reflected light from the object and outputs a signal; and
a processing circuit that controls the light source, the adjuster, and the scanner, and that processes the signal outputted from the photodetector.

The processing circuit performs a first scan operation by causing the scanner to change the irradiation angle, and causing the light source to emit the irradiation light,
generates optical detection information through the first scan operation based on the reflected light detected by the photodetector,
causes the adjuster to set the focus position of a second scan operation based on the optical detection information through the first scan operation,
performs the second scan operation by causing the scanner to change the irradiation angle, and causing the light source to emit the irradiation light,
generates optical detection information through the second scan operation based on the reflected light detected by the photodetector, and
generates distance information of the object based on the optical detection information through the second scan operation.

### Technique 16

The measuring apparatus according to Technique 15,
wherein the first scan operation is to sequentially irradiate n₁ irradiation points on the object with the irradiation light,
the second scan operation is to sequentially irradiate n₂ irradiation points on the object with the irradiation light, and
n₁ is smaller than n₂.

### Technique 17

The measuring apparatus according to Technique 15 or 16,
wherein an amount of change in the irradiation angle in the first scan operation is greater than an amount of change in the irradiation angle in the second scan operation.

### Technique 18

The measuring apparatus according to Technique 15 or 16,
wherein the irradiation points in the second scan operation are each located between the irradiation points in the first scan operation.

### Technique 19

The measuring apparatus according to Technique 15 or 16,
wherein the focus position of each irradiation point in the second scan operation is determined based on optical detection information of an irradiation point matching one of the irradiation points in the first scan operation or an irradiation point located in a vicinity of the one irradiation point.

### Technique 20

The measuring apparatus according to Technique 19,
wherein the irradiation points in the second scan operation have an irradiation matching-point and an irradiation non-matching-point, the irradiation matching-point matching one of the irradiation points in the first scan operation, the irradiation non-matching-point not matching any of the irradiation points in the first scan operation, and
the focus position of the irradiation non-matching-point is determined based on the optical detection information of the irradiation point located in the vicinity of the one irradiation point among the irradiation points in the first scan operation.

### Technique 21

The measuring apparatus according to Technique 15 or 16,
wherein after completing a measurement operation for all multiple scan operations including the first scan operation and the second scan operation, the processing circuit outputs the distance information of the object.

The measuring apparatus in the present disclosure can be utilized for applications such as shape measurement of a structure.

What is claimed is:

1. A measuring apparatus comprising:
a light source that emits irradiation light for irradiating an object;
an adjuster that adjusts a focus position of the irradiation light;
a scanner that changes an irradiation angle of the irradiation light;
a photodetector that detects reflected light from the object and outputs a signal; and
a processing circuit that controls the light source, the adjuster, and the scanner, and that processes the signal outputted from the photodetector,
wherein the processing circuit performs a first scan operation by causing the scanner to change the irradiation angle, and causing the light source to emit the irradiation light,
generates optical detection information through the first scan operation based on the reflected light detected by the photodetector,
causes the adjuster to set the focus position of a second scan operation based on the optical detection information through the first scan operation,
performs the second scan operation by causing the scanner to change the irradiation angle, and causing the light source to emit the irradiation light,
generates optical detection information through the second scan operation based on the reflected light detected by the photodetector, and
generates distance information of the object based on the optical detection information through the second scan operation.

2. The measuring apparatus according to claim 1,
wherein the first scan operation is to sequentially irradiate n₁ irradiation points on the object with the irradiation light,
the second scan operation is to sequentially irradiate n₂ irradiation points on the object with the irradiation light, and
n₁ is smaller than n₂.

3. The measuring apparatus according to claim 1,
wherein an amount of change in the irradiation angle in the first scan operation is greater than an amount of change in the irradiation angle in the second scan operation.

4. The measuring apparatus according to claim 1,
wherein irradiation points in the second scan operation are each located between irradiation points in the first scan operation.

5. The measuring apparatus according to claim 1,
wherein the focus position of each of the irradiation points in the second scan operation is determined based on optical detection information of an irradiation point matching one of the irradiation points in the first scan operation or an irradiation point located in a vicinity of the one irradiation point.

6. The measuring apparatus according to claim 5,
wherein the irradiation points in the second scan operation have an irradiation matching-point and an irradiation non-matching-point, the irradiation matching-point matching one of the irradiation points in the first scan operation, the irradiation non-matching-point not matching any of the irradiation points in the first scan operation, and
the focus position of the irradiation non-matching-point is determined based on the optical detection information of the irradiation point located in the vicinity of the one irradiation point among the irradiation points in the first scan operation.

7. The measuring apparatus according to claim 1,
wherein after completing a measurement operation for all multiple scan operations including the first scan operation and the second scan operation, the processing circuit outputs the distance information of the object.
